(19) United States
(12) Patent Application Publication
(10) Pub. No.: US 2025/0021459 A1
(43) Pub. Date: Jan. 16, 2025

(54) System and Method for Visualizing and Enforcing Cloud Instance Selection Policies

(71) Applicant: Evenkeel Inc., Richmond Hill (CA)

(72) Inventors: Andrew Derek HILLIER, Richmond Hill (CA); Gerald William SMITH, Stouffville (CA); Henry Martin JURGENS, Aurora (CA); Jake Alexander LONDON, Toronto (CA)

(73) Assignee: Evenkeel Inc., Richmond Hill (CA)

(21) Appl. No.: 18/770,215

(22) Filed: Jul. 11, 2024

Related U.S. Application Data
(60) Provisional application No. 63/526,126, filed on Jul. 11, 2023.

(51) Int. Cl. G06F 11/34

(52) U.S. Cl. CPC G06F 11/3414

(57) ABSTRACT

A system and method are provided for analyzing an application workload running in a cloud instance against a cloud provider's catalog and identifying at least one of the instance types and sizes that are unable to host the workload because they have insufficient CPU, memory or other resources to properly service the workload; the instance types and sizes that are unable to host the workload because their technical characteristics and configurations are not suitable for the workload, wherein this can include local disk availability, disk and network configurations, hypervisor compatibility, and other considerations; the instance types and sizes that are not suitable to host the workload because their cost is outside the acceptable range for that workload; or the instance types that are not ruled out by any of these assessments, and hence are suitable for hosting the workload.

### CROSS-REFERENCE TO RELATED APPLICATION(S)

This application claims priority to U.S. Provisional Patent Application No. 63/526,126 filed on Jul. 11, 2023, the entire contents of which are incorporated herein by reference.

### TECHNICAL FIELD

The following generally relates to cloud computing and, more particularly, to controlling the instance types that are used in cloud computing environments.

### BACKGROUND

Cloud computing has become widely adopted across many industries, providing “Infrastructure as a Service” (IaaS) to organizations that require compute resources to host applications and IT services. The public cloud hosting model enables these organizations to replace “on premise” data centers with a more flexible hosting model that lets them rent compute resources, or “cloud instances” from public Cloud Service Providers (CSPs) to run their workloads. These providers include Amazon Web Services, Microsoft Azure, and Google Compute Platform.

These cloud providers offer IaaS instances that are available in multiple sizes and configurations, and are organized into a “cloud catalog” that represents the available offerings from that CSP. The different instance types can have different prices and different availability depending on the geographical region.

Because of the diverse set of offerings available in the cloud catalog, each with very specific resource configurations, storage options, performance characteristics, and other properties, it is very difficult for organizations to select the optimal instance for a given application workload. Without the ability to perform detailed measurement of the running workload and analysis of its requirements against the available offerings, organizations are not able to ensure the right instance types are being used. In order to mitigate risk, they will often err on the side of purchasing instances that are too large and/or over-specified, wasting money and causing unnecessarily large cloud bills.

Moreover, even with a detailed analysis providing the optimal instance type for each workload, it is often challenging to implement these recommendations. Application teams are typically responsible for making sure that their applications are reliable and available, and any recommendations to change the cloud instances they run on need to be accompanied by detailed evidence showing the rationale for and predicted impact of the change, enabling them to properly assess the risk. If these recommendations do not consider the relevant capacity requirements of the workload, the technical and configuration requirements of the instance it runs on, and the cost of that instance, then application teams would not be able to trust the recommendations.

Furthermore, there may be multiple cloud instance types that are acceptable to host a given workload, and application teams require the freedom to make hosting choices that are not purely governed by cost considerations.

### SUMMARY

In one aspect, there is provided a method for analyzing an application workload running in a cloud instance against a cloud provider's catalog and identifying at least one of: a) the instance types and sizes that are unable to host the workload because they have insufficient CPU, memory or other resources to properly service the workload; b) the instance types and sizes that are unable to host the workload because their technical characteristics and configurations are not suitable for the workload, wherein this can include local disk availability, disk and network configurations, hypervisor compatibility, and other considerations; c) the instance types and sizes that are not suitable to host the workload because their cost is outside the acceptable range for that workload; or d) the instance types that are not ruled out by any of these assessments, and hence are suitable for hosting the workload.

In certain example embodiments, the acceptable range for the cost of an instance is calculate relative to the optimal instance type for that workload, where the optimal instance type is determined using an optimization function that factors in utilization, technical compatibility and cost.

In certain example embodiments, the acceptable range for the cost relative to the optimal instance is defined by a spend tolerance policy, which expresses the maximum acceptable cost as a multiple of the cost of the optimal instance.

In certain example embodiments, the technical criteria include whether a given catalog instance has hardware accelerators or other features that will cause it to have a performance, security or cost advantage over other instance types for the specific software that is running in the workload being assessed.

In another aspect, there is provided a system visualizing the assessment of the method.

In another aspect, there is provided an API to respond to queries as to whether a specific instance type is suitable for hosting a specific workload used with the method of claim 1.

In another aspect, there is provided a method for controlling the deployment of cloud instances in a cloud computing environment, the method comprising: a) analysing an existing cloud workload's configuration and utilization data against a cloud provider's catalog of available instance types; b) identifying the instance types in the catalog that have insufficient resources to host the workload based on the utilization characteristics of the workload and the resource capacity of the instance types; c) identifying the instance types in the catalog that are technically incompatible with the workload based on it's technical and configuration requirements; d) identifying the instance types in the catalog that are too expensive based on a spend tolerance policy; identifying the instance types in the catalog that are deemed suitable to host the workload, by virtue of them not having failed the resource, compatibility and cost checks; and either allowing a deployment to proceed, issuing a warning, or blocking the deployment of a cloud instance based on whether the instance type being deployed is suitable for that cloud workload based on this analysis.

In certain example embodiments, the spend tolerance policy us evaluated based on the ratio of the cost of the instance type being deployed to the optimal instance type in the entire catalog.

In another aspect, there is provided a method of visualizing a 2-dimensional catalog map for a specific cloud instance, where said map has one dimension representing the instance families present in the cloud provider and another dimension representing the instance sizes, and for each family and size combination that exists in the catalog, a color coded cell is depicted.

In certain example embodiments, the color coded cell is based on the logic described in the method above.

Computer readable media for performing the above methods are also provided.

### BRIEF DESCRIPTION OF THE DRAWINGS

Embodiments will now be described with reference to the appended drawings wherein:

FIG. 1 is a depiction of a cloud computing environment with various compute, storage and networking components, as well as the optimization system.

FIG. 2 is a diagram of the components of the optimization system.

FIG. 3 is a diagram of the computing device that the optimization system runs on.

FIG. 4 depicts the analysis of workload data where the raw utilization metrics are processed and turned into normalized pattern models.

FIG. 5 shows the analysis of a cloud instance against a portion of a cloud provider's catalog, using policies comprised of detailed rules, in order to determine the optimal instance type to run on.

FIG. 6 shows the detailed rule processing results for an instance type that is deemed unsuitable to host that cloud workload.

FIG. 7a shows rule processing results for a case where a specific piece of software running on the instance is matched with a CPU accelerator that will benefit the performance of that software.

FIG. 7b shows rules that enable matching of Artificial Intelligence (AI) software with CPU accelerators that benefit AI workloads.

FIG. 8 highlights a set of instance types that are all deemed suitable to host a specific cloud workload.

FIG. 9a shows a conceptual 2-dimensional “map” model of a cloud catalog, depicting how the suitable and unsuitable instance types can be visualized for a given cloud workload.

FIG. 9b shows how this model changes if a spend tolerance policy is adjusted to reflect a lower tolerance for financial waste.

FIG. 9c shows the extreme case where there is no tolerance for waste, and the only suitable instance type is the one with the lowest cost.

FIG. 10a shows how this conceptual model translates into an actual cloud catalog, and how the shape of the “map” is dictated by the available instance families and sizes, in this case showing the Amazon Web Services (AWS) Elastic Compute Cloud (EC2) catalog.

FIG. 10b shows a “commonly used” map for AWS EC2, eliminating many of the unusual and oddly sized instance types.

FIG. 11 shows a “commonly used” map for Microsoft Azure.

FIG. 12a shows an analysis console with multiple AWS EC2 cloud instances being analyzed.

FIG. 12b shows a catalog map corresponding to one of the AWS EC2 instances in the analysis console.

FIG. 12c shows a catalog map where a red cell is selected, and the reason it is deemed unsuitable is reported in the table below.

FIG. 12d shows a catalog map where an orange cell is selected, and the reason it is deemed unsuitable is reported in the table below.

FIG. 12e shows a catalog map where a yellow cell is selected, and the reason it is deemed unsuitable is reported in the table below.

FIG. 12f shows a case where the spend tolerance is decreased, and the number of suitable instance types (green cells) in the map also decreases.

FIG. 12g shows a case where the spend tolerance is further decreased, and the number of suitable instance types (green cells) in the map also further decreases.

FIG. 12h shows a case where the spend tolerance is decreased to “zero tolerance”, and only one suitable instance type (green cell) remains in the map.

FIG. 12i shows a case where a specific processor accelerator (AMX) is selected, and all instance types that contain CPUs with that accelerator are highlighted.

FIG. 12j shows the full catalog for AWS EC2.

FIG. 12k shows the full catalog for AWS EC2, but filtered to only show instance types containing Intel CPUs.

FIG. 12l shows a catalog map for an AWS Relational Database Service (RDS) instance, which has a different set of supported instance families and sizes.

FIG. 13a shows an analysis console with multiple Microsoft Azure cloud instances being analyzed.

FIG. 13b shows a catalog map corresponding to one of the Microsoft Azure instances in the analysis console.

FIG. 14a shows a flow diagram with multiple options for implementing an optimization recommendation.

FIG. 14b shows a novel flow that uses a policy engine to enable a catalog map to be used as “guardrails” when deploying cloud instances.

FIG. 14c shows an optional escalation process where ignoring warnings can cause a deployment to be blocked.

FIG. 15 is a sequence diagram describing the flows in FIGS. 14b and 14c

FIG. 16 shows a flow where a member of a Financial Operations (FinOps) team adjusts the spend tolerance policy downward, causing the policy engine to reject a cloud instance deployment.

FIG. 17 is a sequence diagram describing the flow in FIG. 16.

FIG. 18a is a code fragment from a policy that implements the logic shown in the prior figures, targeting instance types that are either technically incompatible or that have insufficient resources.

FIG. 18b is a code snippet from a policy that implements the logic shown in the prior figures, targeting instance types that are outside spend tolerance.

FIG. 19a is a screenshot from the Hashicorp Terraform console showing the policy failure scenario, where the instance being deployed is found to be technically incompatible.

FIG. 19b is a screenshot from the Hashicorp Terraform console showing the policy failure scenario, where the instance being deployed is found to be outside spend tolerance.

FIG. 19c is a screenshot from the Hashicorp Terraform console showing the policy pass scenario, where the instance being deployed is found to be within the spend tolerance.

FIG. 20 shows an alternative use of the map construct, in this case with the cells of the map being used to indicate the total number of instances of that type present in a cloud environment.

FIG. 21 shows an shows an alternative use of the map construct, in this case showing the deltas in the numbers of instances of each type in use that would be caused by implementing optimization recommendations.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

In order to address the above-noted challenges, analysis software has been developed that is able to assess the acceptability or suitability of each instance in the cloud catalog for a given application workload, using policies that are able to assess the utilization and technical compatibility of the workload against each instance type and size, as well as the cost of each instance. This, combined with a new “spend tolerance” policy, enables the analysis to provide a set of acceptable instance choices for a given workload (or, conversely, a set of unacceptable choices). When available via an API, this capability allows third party policy engines to call in to the software to assess the instance selection each time a cloud instance is deployed.

By assessing each cloud instance being deployed based on utilization, technical compatibility and cost policies, this approach effectively creates “guardrails” that let the application teams choose whatever instance type and size that they like, as long as their instance choices do not violate the policies. This represents a significant advancement over previous optimization methods, where the single optimal instance type is captured for each workload and communicated to the application owners as a recommendation. This rigid approach gave no leeway to the application teams, and required them to either trust the recommendation or reject it.

In addition to the API-based governance capabilities, a new visualization has been created that enables application teams to see the entire cloud catalog, or subsets of it, in a 2-dimensional “catalog map”, with one axis showing the available instance types, and the other showing the available sizes.

By providing analysis scores and color-coding for each instance in the catalog, it is possible to intuitively and rapidly see which instances are suitable for a given workload and which are not. It is also possible to see why a given instance type is or is not suitable, providing visibility into what specific criteria it cannot meet. This provides an intuitive view of the options available for a given workload, allows exploration of other options beyond the single recommended instance type, and generates trust in the application owners that the recommendations are taking into account all of the criteria that are important to them.

The following describes a system and method for analyzing an application workload running in a cloud instance against a cloud provider's catalog. The system and method are configured to identify the instance types and sizes that are unable to host the workload because they have insufficient CPU, memory or other resources to properly service the workload. The system and method also identify the instance types and sizes that are unable to host the workload because their technical characteristics and configurations are not suitable for the workload. This can include local disk availability, disk and network configurations, hypervisor compatibility, and other considerations. The system and method are also configured to identify the instance types and sizes that are not suitable to host the workload because their cost is outside the acceptable range for that workload. The system and method are also configured to identify the instance types that are not ruled out by any of these assessments, and hence are suitable for hosting the workload.

In the proposed system and method, the acceptable range for the cost of an instance can be calculated relative to the optimal instance type for that workload, where the optimal instance type is determined using an optimization function that factors in utilization, technical compatibility and cost. In such an implementation, the acceptable range for the cost relative to the optimal instance may be defined by a spend tolerance policy, which expresses the maximum acceptable cost as a multiple of the cost of the optimal instance. Alternatively, this may be a maximum tolerable difference in absolute terms (e.g., less than $50 difference, not 2×).

In the proposed system and method, the technical criteria can include whether a given catalog instance has hardware accelerators or other features that will cause it to have a performance, security or cost advantage over other instance types for the specific software that is running in the workload being assessed.

The system and method can provide the ability to visualize the assessment of the above and/or an additional system and method may be provided.

The following also describes an application programming interface (API) to respond to queries as to whether a specific instance type is suitable for hosting a specific workload.

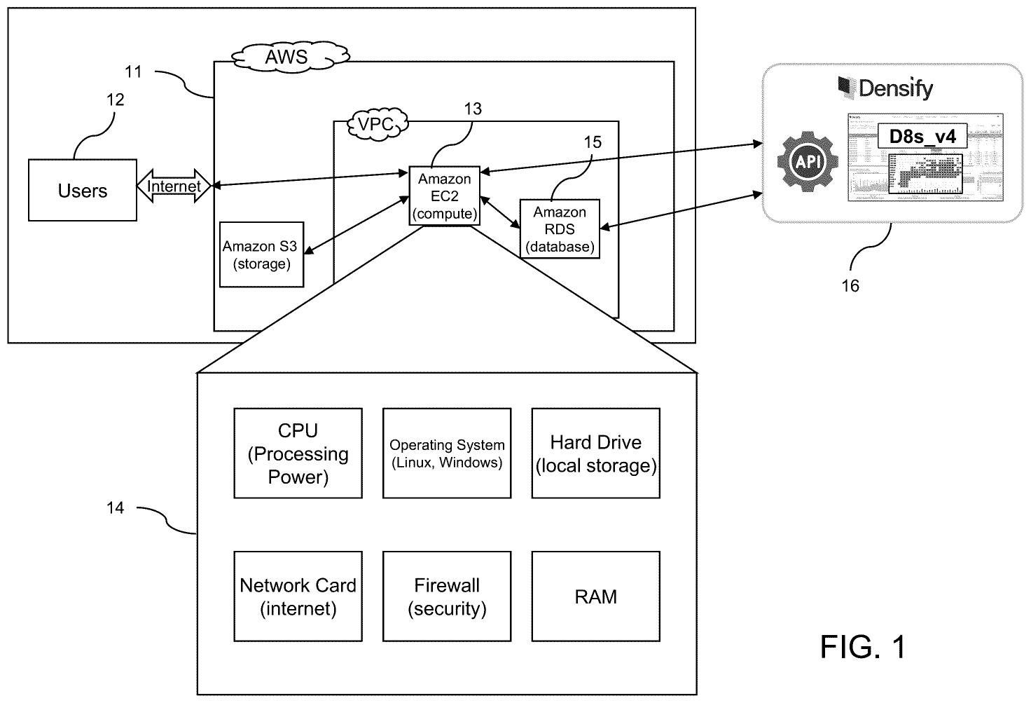

FIG. 1 depicts a cloud computing environment, where infrastructure as a service, or IaaS, is made available by a cloud provider 11, and used by tenants 12 to host application and business service workloads. This infrastructure is made available to customers as cloud instances 13, and is available in differing sizes and configurations 14, often referred to as instance types. These have differing capabilities, capacity, and performance characteristics, and can be purchased and used in flexible ways, including by the hour, and the per-instance price varies based on it's size and characteristics. In addition to compute services, cloud providers also provide database services 15 and a variety of other offerings.

This disclosure provides a method and system 16 for optimizing the instance types being used in order to ensure they meet all of the technical and resource requirements of the applications and business services being hosted, while also ensuring they do not incur excessive cost. By analyzing the workloads against the catalog of instance types on offer in the cloud provider, this can detect cases where unsuitable instance types are being deployed, and recommend alternatives that are more suitable

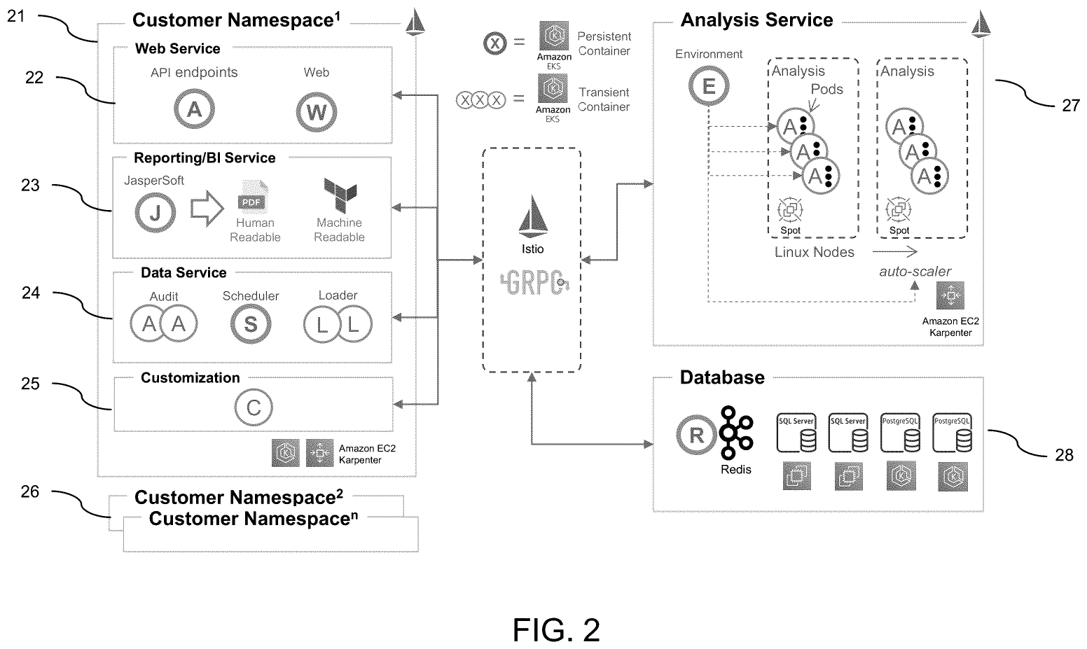

FIG. 2 illustrates further detail of the optimization system. The system comprises several components, including a customer-specific namespace 21, a central analysis service 27, and both relational and timeseries database services 28. Within the customer namespace there is a web services interface 22 enabling both web-based access for end users as well as API access. A reporting and business intelligence service 23 provides further capabilities for end users. A data service 24 provides the ability to acquire data from remote cloud environments, and a customization service 25 supports customer-specific configurations that are not shared between customers. These services are duplicated for each customer namespace 26, ensuring separation of customer data and access.

This collectively provides a system to optimize the selection of instance types for each individual workload, the system comprising a data collection framework, and analysis framework, storage database, user interface and application programmer interfaces (APIs)

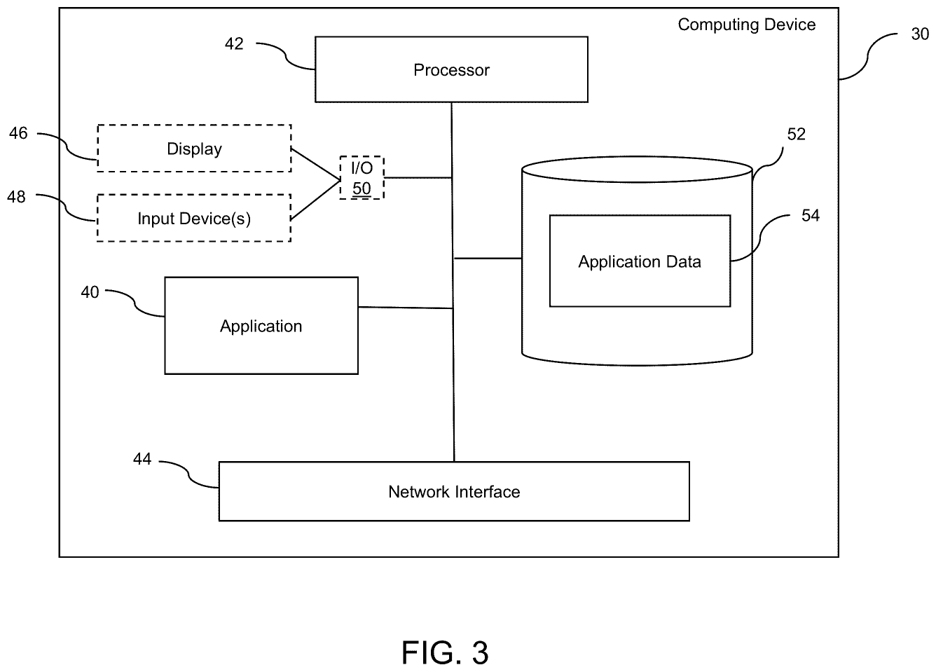

FIG. 3 shows an example of a computing device 20 which may be utilized by any one or more of the entities shown in FIGS. 1 and 2, for example, a personal electronic device or server used to provide the governance engine 16 or other computing device 20 used to communicate with the entities shown in FIGS. 1 and 2. The computing device 20 in FIG. 3 may, additionally or alternatively, provide an example of a device on which these entities may be deployed or accessed.

In this example, the computing device 20 includes one or more processors 42 (e.g., a microprocessor, microcontroller, embedded processor, digital signal processor (DSP), central processing unit (CPU), media processor, graphics processing unit (GPU) or other hardware-based processing units) and one or more network interfaces 44 (e.g., a wired or wireless transceiver device connectable to a network via a communication connection).

Examples of such communication connections can include wired connections such as twisted pair, coaxial, Ethernet, fiber optic, etc. and/or wireless connections such as LAN, WAN, PAN and/or via short-range communications protocols such as Bluetooth, WiFi, NFC, IR, etc.

The computing device 20 may also include an application 40 (or other application(s)), a data store 52, and client application data 54.

The data store 52 may represent a database or library or other computer-readable medium configured to store data and permit retrieval of data by the computing device 20. The data store 52 may be read-only or may permit modifications to the data. The data store 52 may also store both read-only and write accessible data in the same memory allocation. In this example, the data store 52 stores the application data 54 for the application 40 that is configured to be executed by the computing device 20 for a particular role or purpose.

While not delineated in FIG. 3, the computing device 20 includes at least one memory or memory device that can include a tangible and non-transitory computer-readable medium having stored therein computer programs, sets of instructions, code, or data to be executed by processor(s) 42. The processor(s) 42 and network interface(s) 44 are connected to each other via a data bus or other communication backbone to enable components of the computing device 20 to operate together as described herein. FIG. 3 illustrates examples of modules and applications stored in memory on the computing device 20 and executed by the processor(s) 42.

It can be appreciated that any of the modules and applications shown in FIG. 3 may be hosted externally and may be available to the computing device 20, e.g., via a network interface 44. The data store 52 in this example stores, among other things, the application data 54 that can be accessed and utilized by the application 12. The data store 52 may additionally store one or more software functions or routines in a cache or in other types of memory.

As shown in FIG. 3, the computing device 20 may, optionally (e.g., when configured as a personal electronic device such as a smartphone or tablet), include a display 46 and one or more input device(s) 48 that may be utilized via an input/output (I/O) module 50. That is, such components may be omitted when the computing device 20 does not interact with a user.

While examples referred to herein may refer to a single display 46 for ease of illustration, the principles discussed herein may also be applied to multiple displays 46, e.g., to view portions of UIs rendered by or with the application 40 on separate side-by-side screens. That is, any reference to a display 46 may include any one or more displays 46 or screens providing similar visual functions. The application 40 receives one or more inputs from one or more input devices 48, which may include or incorporate inputs made via the display 46 as well as any other available input to the computing environment 10 (e.g., via the I/O module 50), such as haptic or touch gestures, voice commands, eye tracking, biometrics, keyboard or button presses, etc. Such inputs may be applied by a user 22 interacting with the computing environment 10, e.g., by operating the computing device 20 as illustrated in FIG. 1.

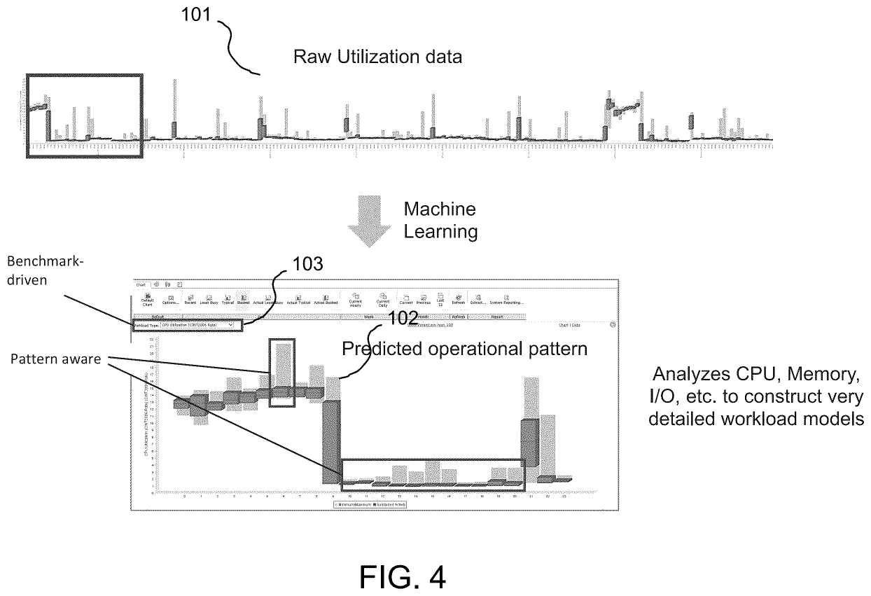

FIG. 4 depicts a workload analysis system where raw time-series utilization data 101 is obtained from the cloud provider for an existing cloud workload running on an existing cloud instance, and is processed in order to construct representative models of that workload's characteristics 102. These models represent CPU utilization, memory utilization, disk and network I/O activity, and other key metrics that are needed to determine how much resources a workload requires. For CPU utilization, the data is preferably normalized using benchmarks 103 in order to enable proper comparisons between different infrastructure offerings with different ages and performance characteristics

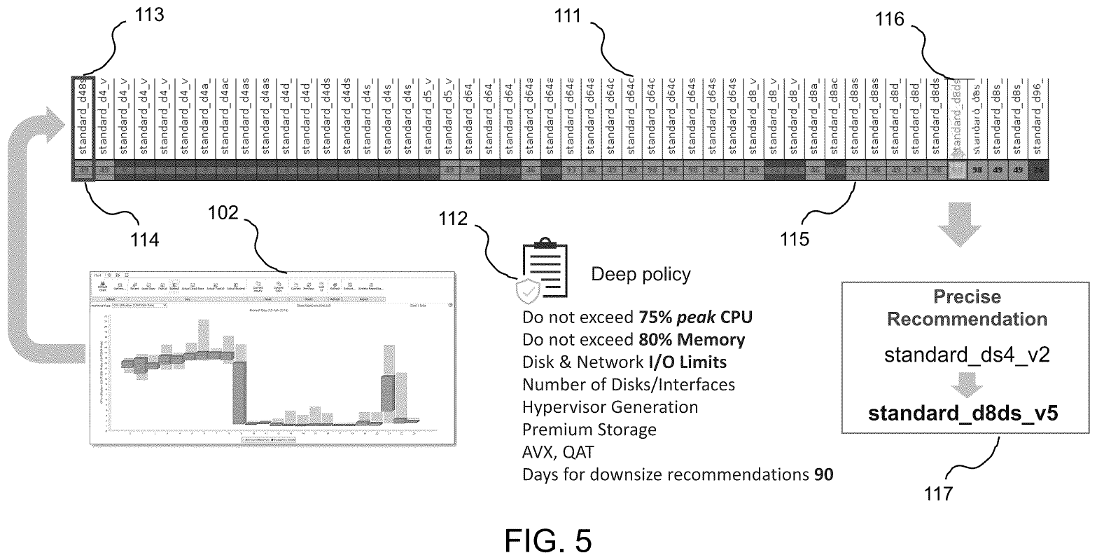

FIG. 5 is an analysis of an existing cloud workload against a portion of a cloud provider's catalog 111. The analysis employs a policy model 112 that defines rules and thresholds for determining the suitability of a given cloud instance for hosting the cloud workload. The thresholds are used to determine whether there is sufficient capacity on a specific instance type 113 to host the workload 102. The rules are used to determine whether a specific instance type is suitable from a technical perspective. This includes factors such as storage and networking configurations and capabilities, processor type and features, software and driver requirements, boot image compatibility, and other considerations.

Using this policy 112 the cloud workload 102 is analyzed against each entry in the catalog to generate a score 114 that represents whether that instance type is suitable to host the workload. If an instance type is deemed suitable then it will receive a higher score, and will be depicted as a green cell 115 in the visual representation. If an instance type is deemed unsuitable then it will be color coded as yellow, orange or red, depending on the nature of the incompatibility. The highest scoring instance type will be deemed the optimal instance type 116, generating an optimization recommendation 117.

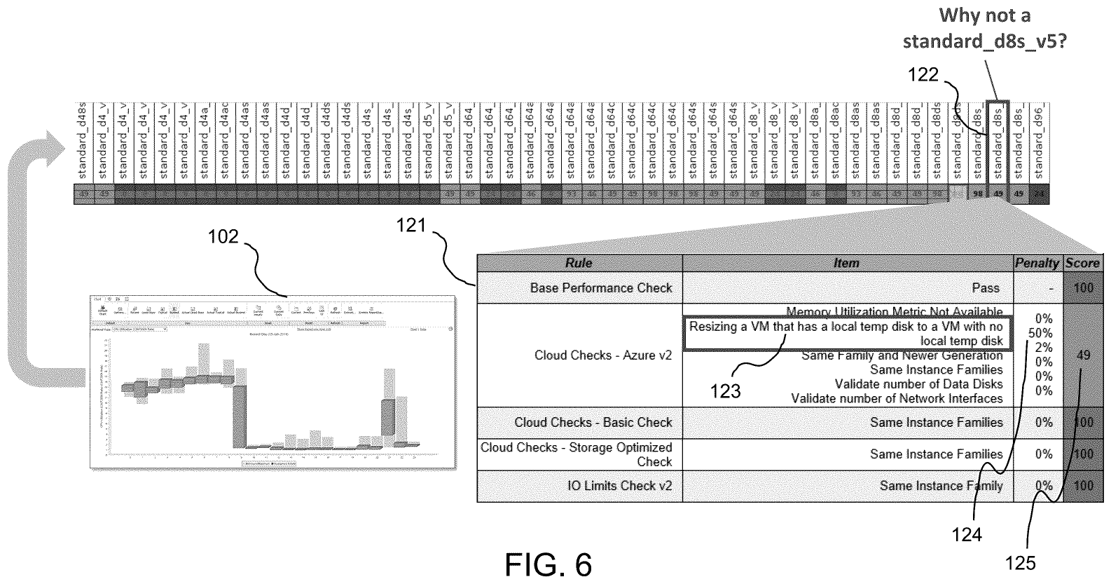

FIG. 6 shows the detailed rule processing results 121 for a cloud instance type 122 that was deemed unsuitable to host a specific workload 102. A specific rule 123 was triggered, in this case indicating that the workload being analyzed has a local disk, but that the instance type 122 does not, which makes it unsuitable to host that workload. This rule has a penalty weight 124 associated with it, and an overall score 125 is generated based the complete set of rule infractions.

This score is then combined with the assessment of the resource utilization characteristics of the workload 102 against the resource capacity of the instance type 122 in order to generate the overall score for the instance type 122.

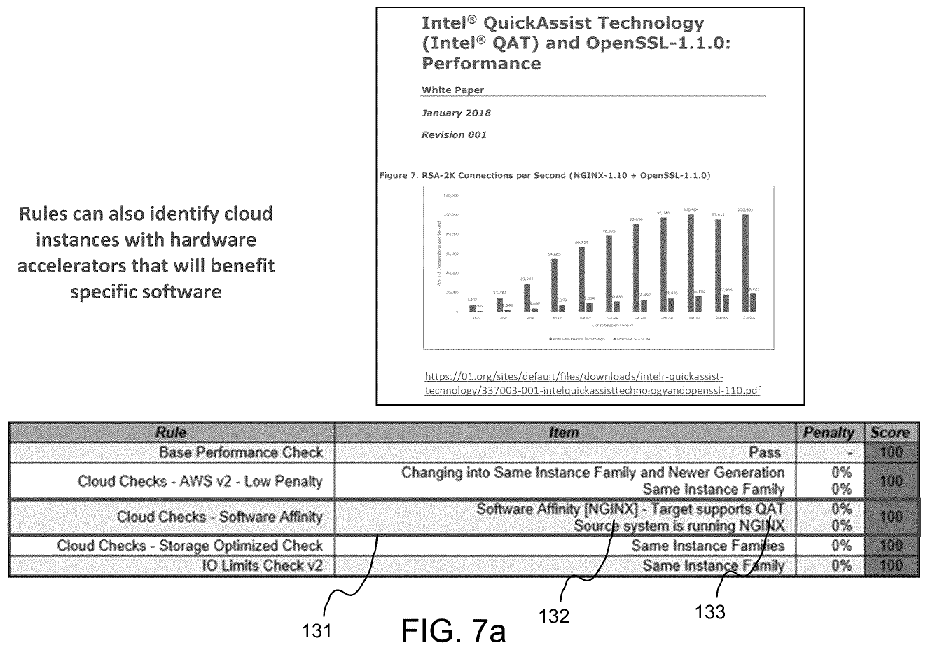

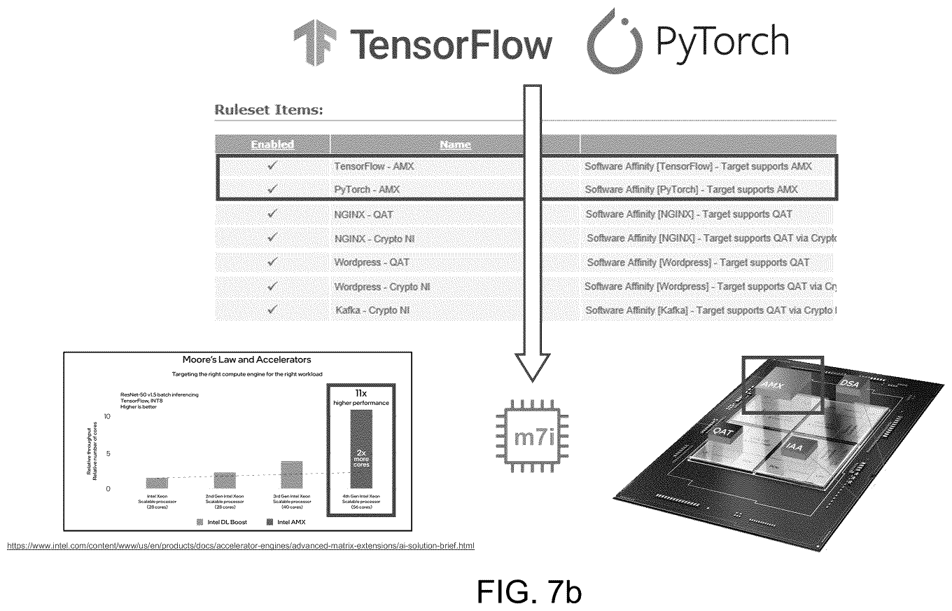

FIG. 7 shows an example of a software affinity policy rule 131 that is designed to match specific software components 132 that are running on a cloud workload to instance types that have specific features 133. In this example a workload that is running the NGINX software is being assessed against an instance type that includes a processor accelerator called Intel® QuickAssist, which accelerates encryption operations. The NGINX software relies heavily on encryption, and by hosting the cloud workload on this instance type there will be a performance advantage 134. By modeling this as rules in the policy, this instance type will obtain a higher score than instance types without this particular feature, thus impacting the instance suitability determination.

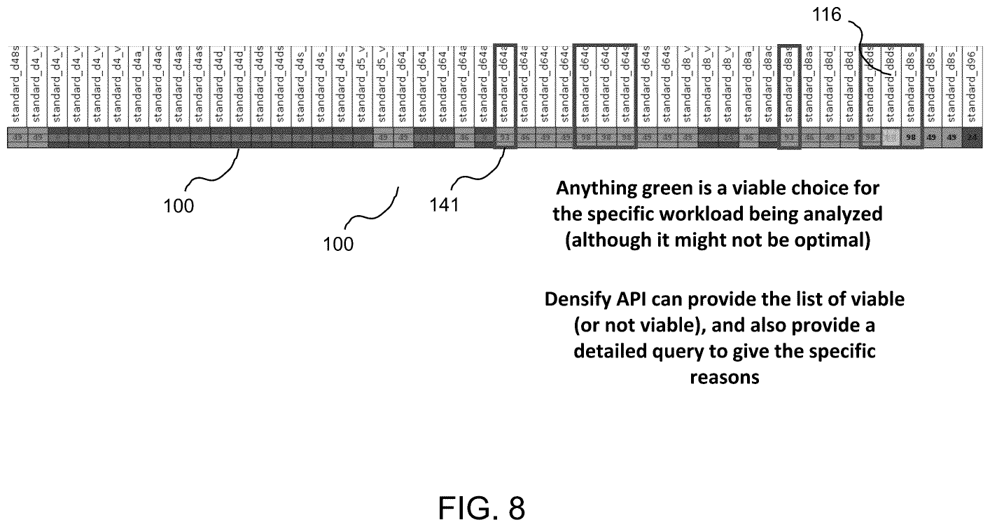

FIG. 8 shows the set of cloud instance types 141 that were deemed suitable for hosting a specific workload, represented as green cells in the visual representation. Even though the analysis selects a single optimal instance type 116, which scored best on all of the various criteria, any of the suitable instance types 141 can be used to host the workload.

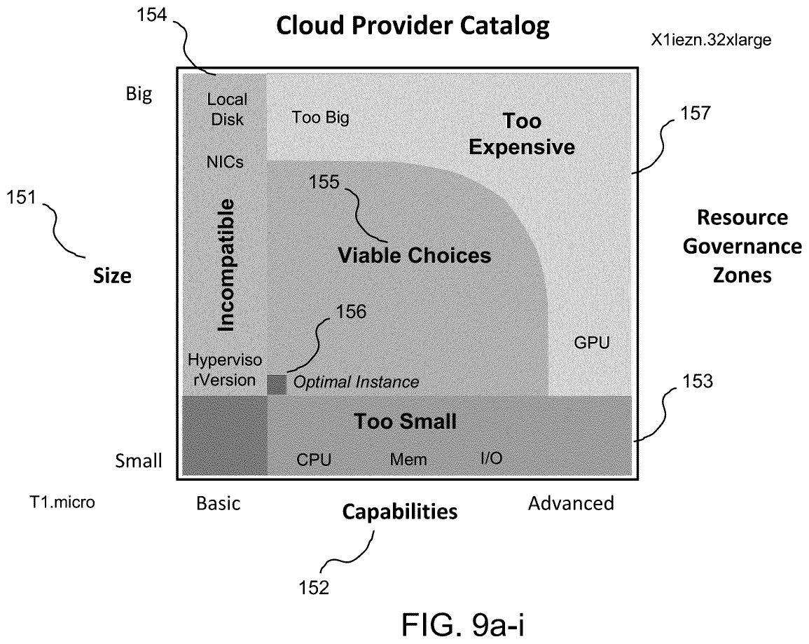

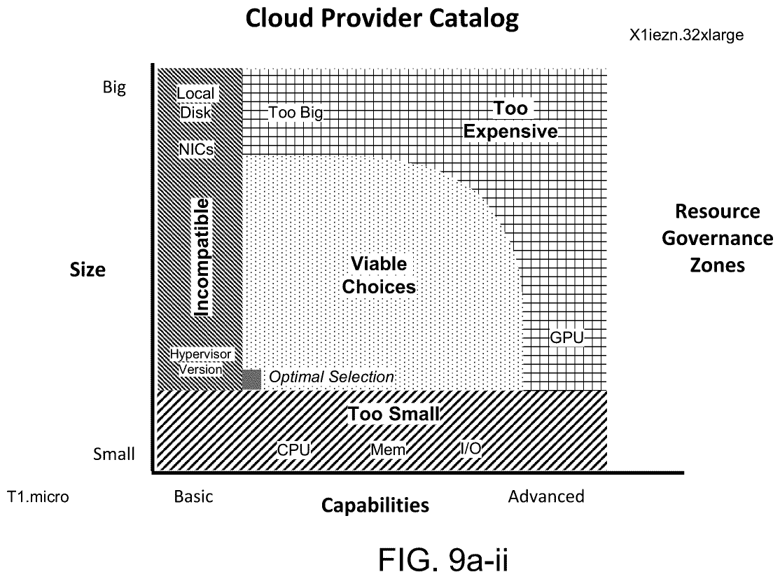

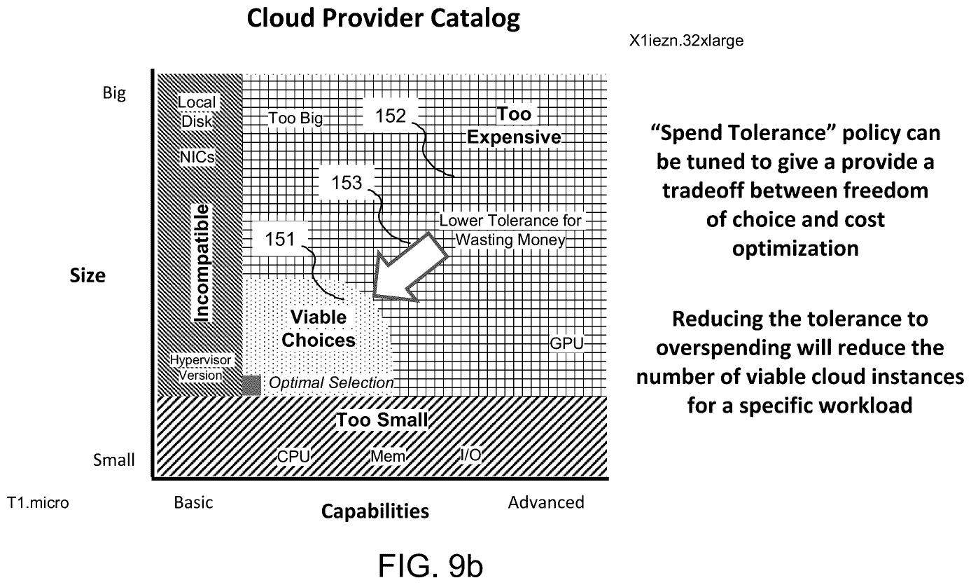

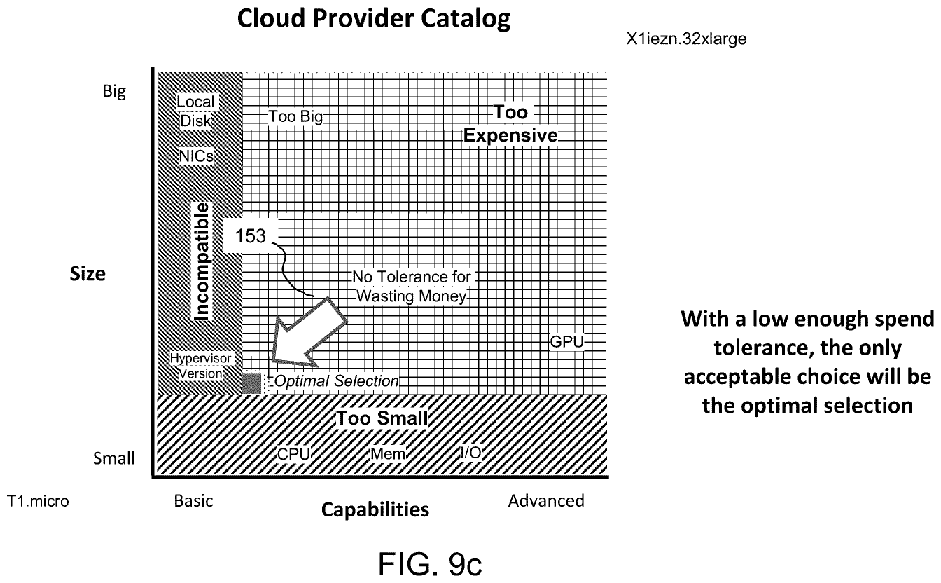

FIG. 9a represents a theoretical 2-dimensional model of the assessment of a cloud workload against a cloud catalog. In this model, the cloud catalog is abstracted into a two dimensional map representing both the sizes of the instances 151 and the capabilities of the instances 152. The sizes are sorted vertically, with the smallest instance types at the bottom and the largest at the top. The capabilities are similarly sorted horizontally, with the most basic (and cheapest) on the left, and the most advanced (and most expensive) on the right.

For a given workload there will be a set of instance types that have insufficient resources to meet the needs of the workload, and this set can be depicted on the map as a red “too small” zone 153 at the bottom of the model. There will also be a set of instance types that do not possess the required features, capabilities or configurations that are required by the workload, as determined by the rule processing 121. This set can be represented on the map as an orange “incompatible” zone on the left of the diagram 154. Note that because of the nature of the cloud catalog, this zone may be fragmented, and may not be strictly to the left of the model. For example, if an expensive GPU-enabled instance type does not have a local disk, then orange “stripes” may appear on the right side of the map.

As we move away from the optimal instance, both upward and to the right in the map, the instance types will theoretically become more expensive, and at some point will be deemed unsuitable due to cost. This is represented on the map as a yellow “too expensive” zone 157 in the map.

For instances that are not ruled out as being too small, incompatible, or too expensive, and are thus deemed suitable by the analysis 141, there will be a zone representing “viable choices” 155. And within this zone is the optimal instance 156. Because of the varying sizes and capabilities of the cloud instances in a catalog, the set of viable choices will vary in cost, and the optimal instance type is typically the one that is deemed suitable and has the lowest cost. In this model that would typically be the smallest and least capable instance type that still meets the requirements, placing it at the bottom left of the green zone. Note that depending on the policy in force this might not always be the case, and a more performant instance might score higher, even if it is more expensive.

FIG. 9b shows a variant on this map where the acceptable cost is lower than in the previous figure. This reduces the set of viable choices 151, shrinking the green zone, and increases the set of too expensive instance types 152, growing the yellow zone. This threshold for acceptable cost is referred to as the spend tolerance, which is a key aspect of this invention. Varying the spend tolerance 153 will change the results of the analysis, increasing and decreasing the gamut of acceptable instance types for a given cloud workload.

FIG. 9c shows the extreme case where the spend tolerance is decreased to the point where there are very few viable instances, or even just one. This “zero tolerance” scenario represents scenarios where any financial waste is unacceptable. This provides the highest cost efficiency, but comes at the expense of freedom of choice.

Although an abstract model, this thought process was the precursor to, and enabled the creation of, the actual catalog map model and the API interfaces that are the foundation of the system described herein.

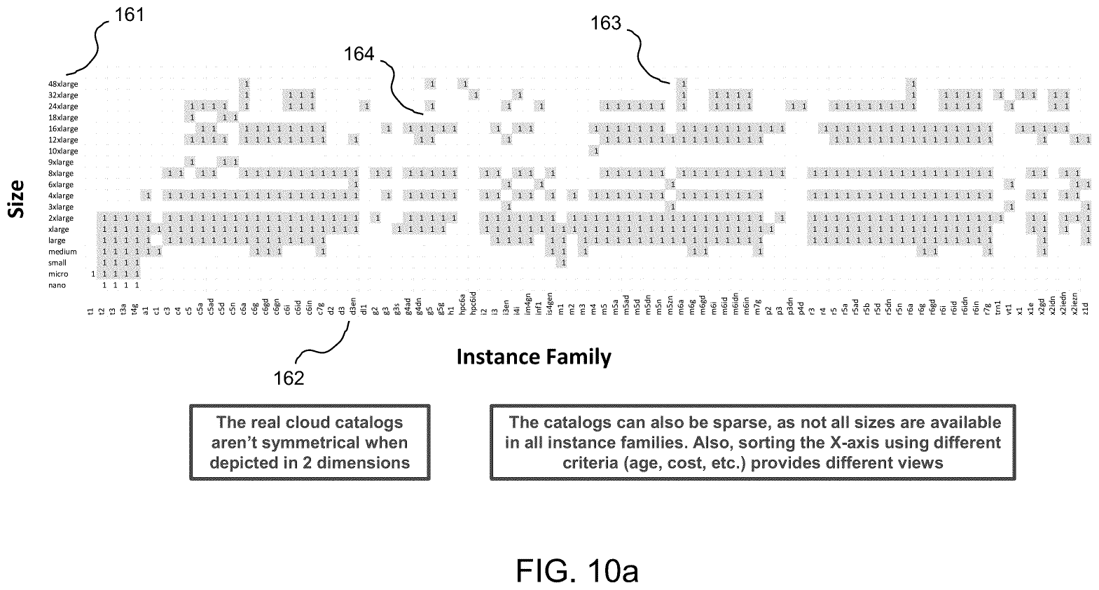

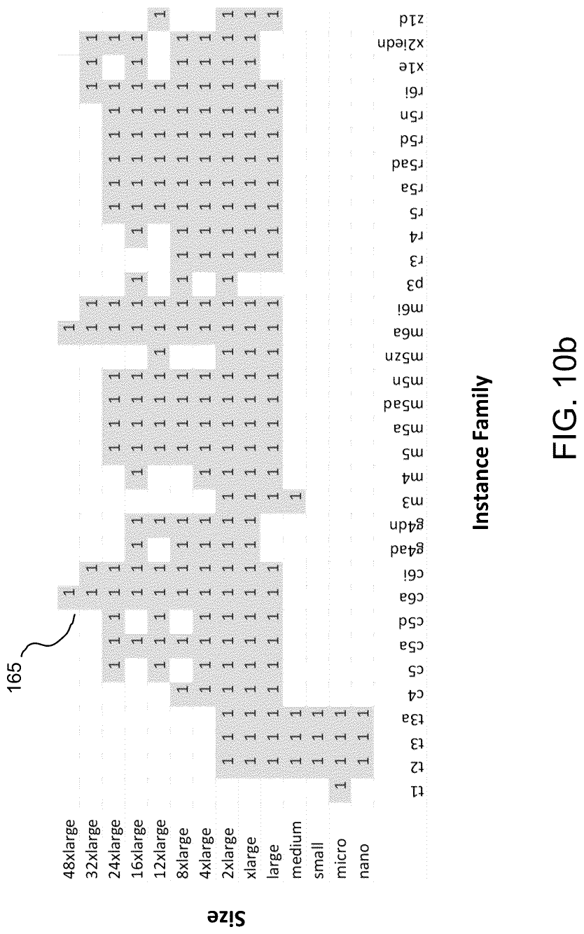

FIG. 10a shows a 2-dimensional map of the instance types that are available in an actual cloud provider's instance catalog, in this case the Amazon Web Services (AWS) Elastic Compute Cloud (EC2). Up the left are the sizes offered 161, and across the bottom are the instance “families” 162 with differing capabilities. In AWS EC2 these families include general purpose, compute optimized, memory optimized, burstable, GPU enabled, and others.

In this figure the set of populated cells in the map 163 represent the instance types that exist in the catalog and are available to use. Because the number of different sizes available is less than the number of distinct families, the boundary of the map is rectangular, and not square like the abstract model. And because not all instance families are available in all sizes, the map is sparse, with blank regions 164 that do not have a corresponding instance type that can be purchased.

FIG. 10b shows a subset of the instance types 165 that represents the “commonly used” instance types. Because some instance families and/or sizes are highly specialized and are not commonly used, they can be considered “exotic”, and removing them from the map simplifies the representation. For example, focusing on the instance types that are used 99.9% of the time gives a representation similar to this figure.

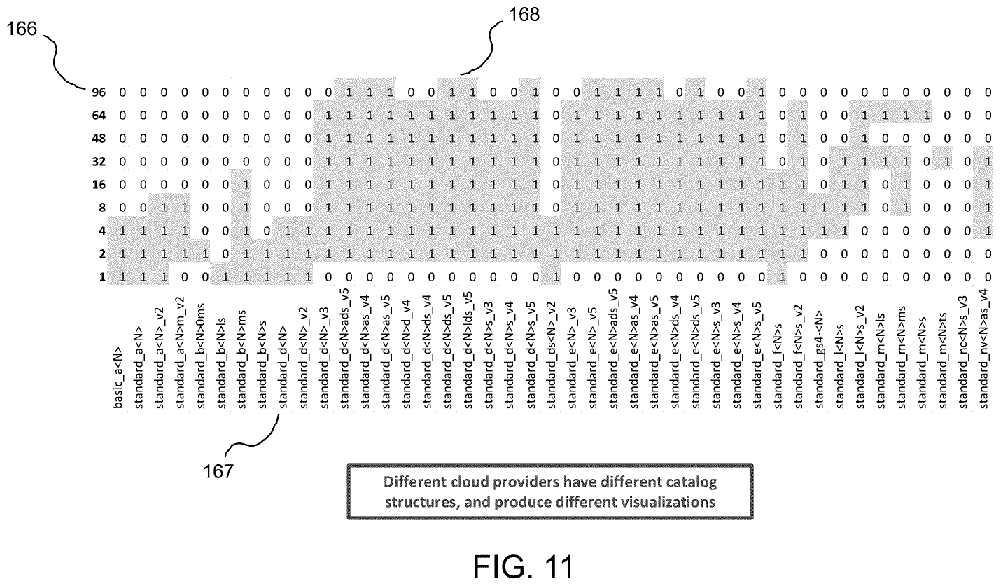

FIG. 11 shows the commonly used instance types that are available in Microsoft's Azure cloud. This cloud provider offers a different set of instance sizes 171, and has a different set of families 172 than AWS EC2, causing the representation of the commonly used instances 173 to have a different shape.

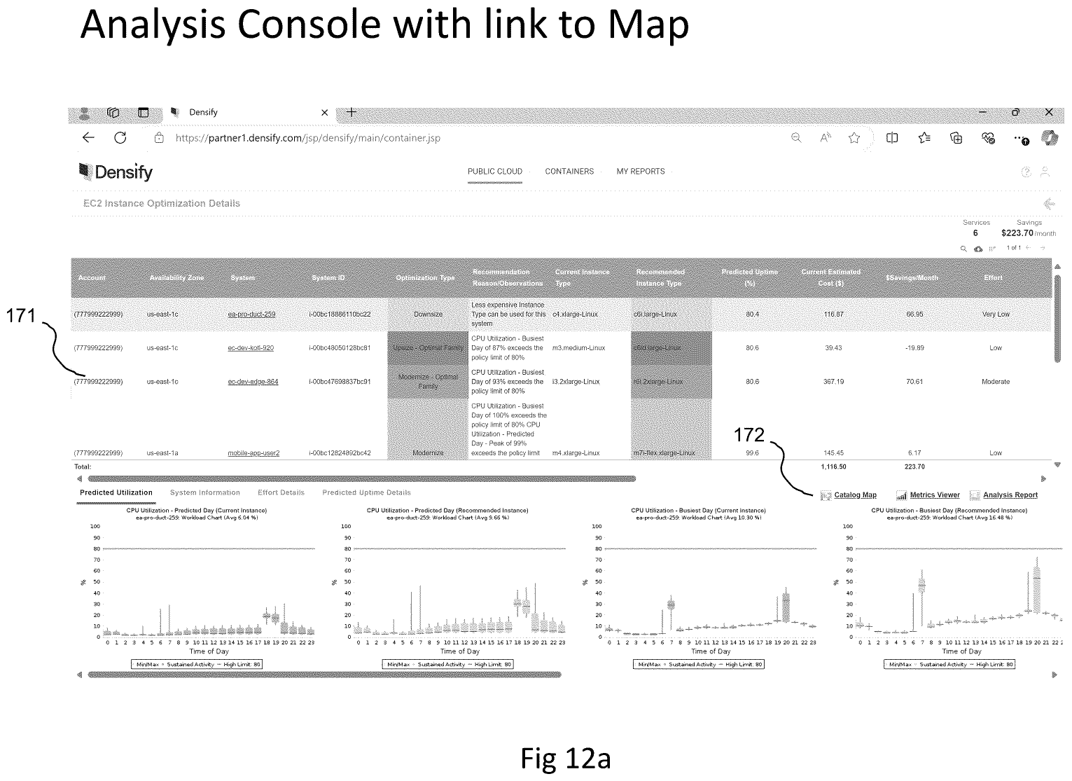

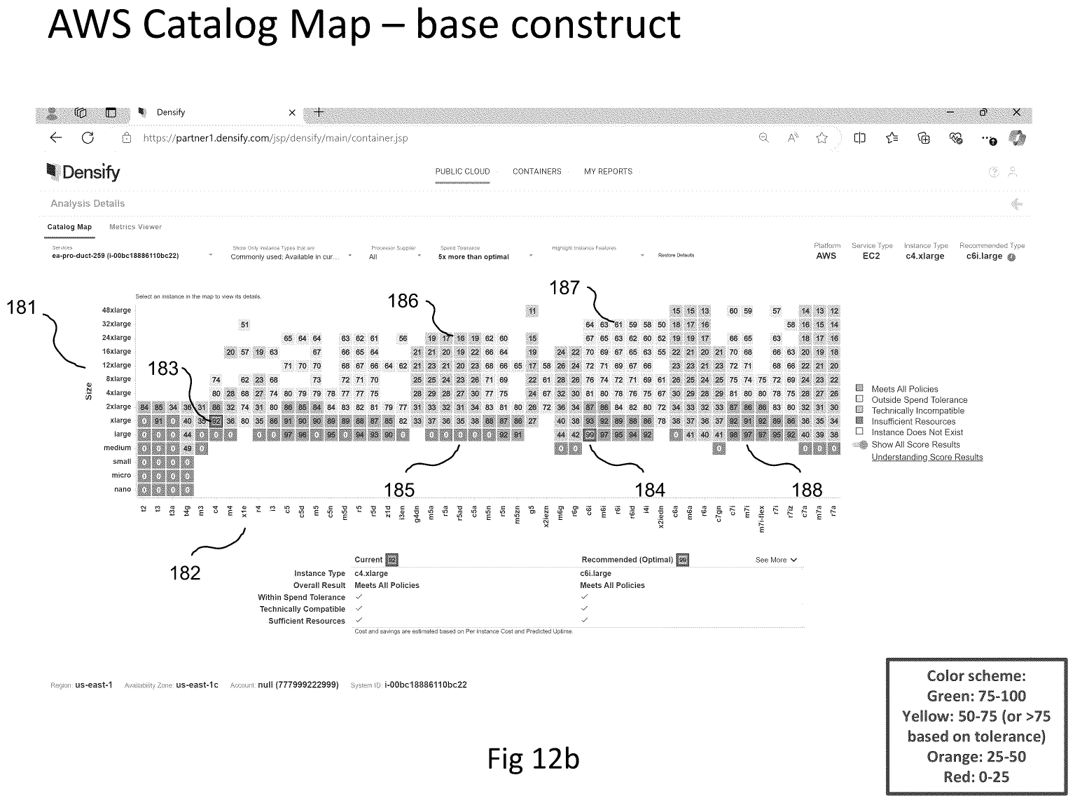

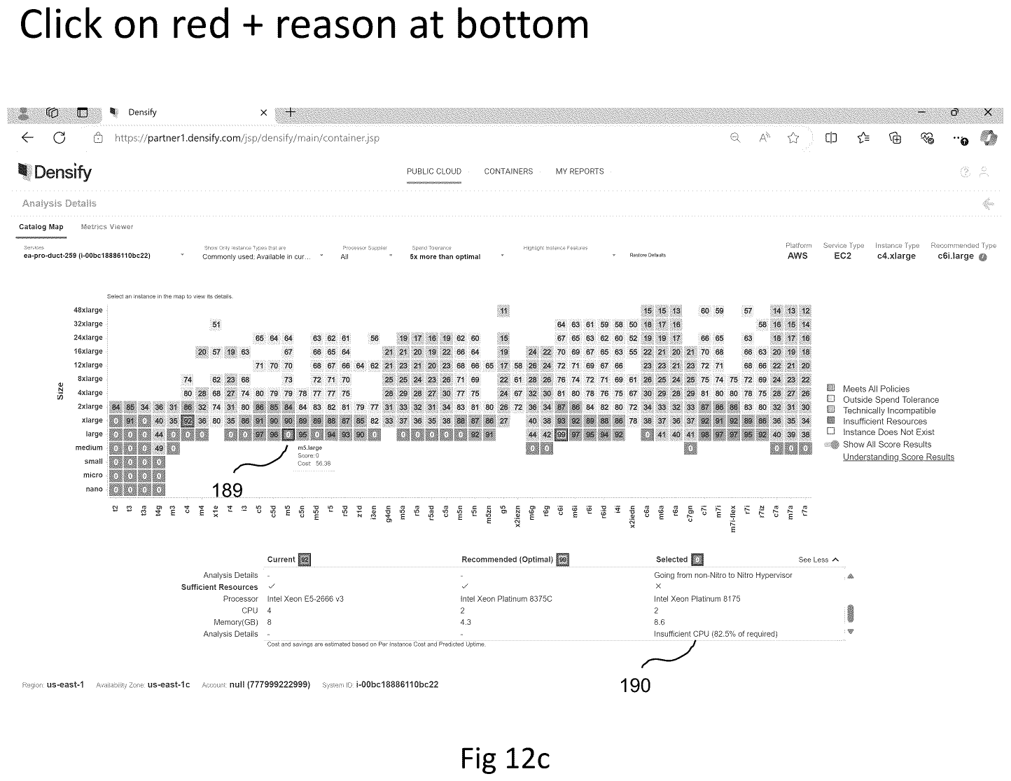

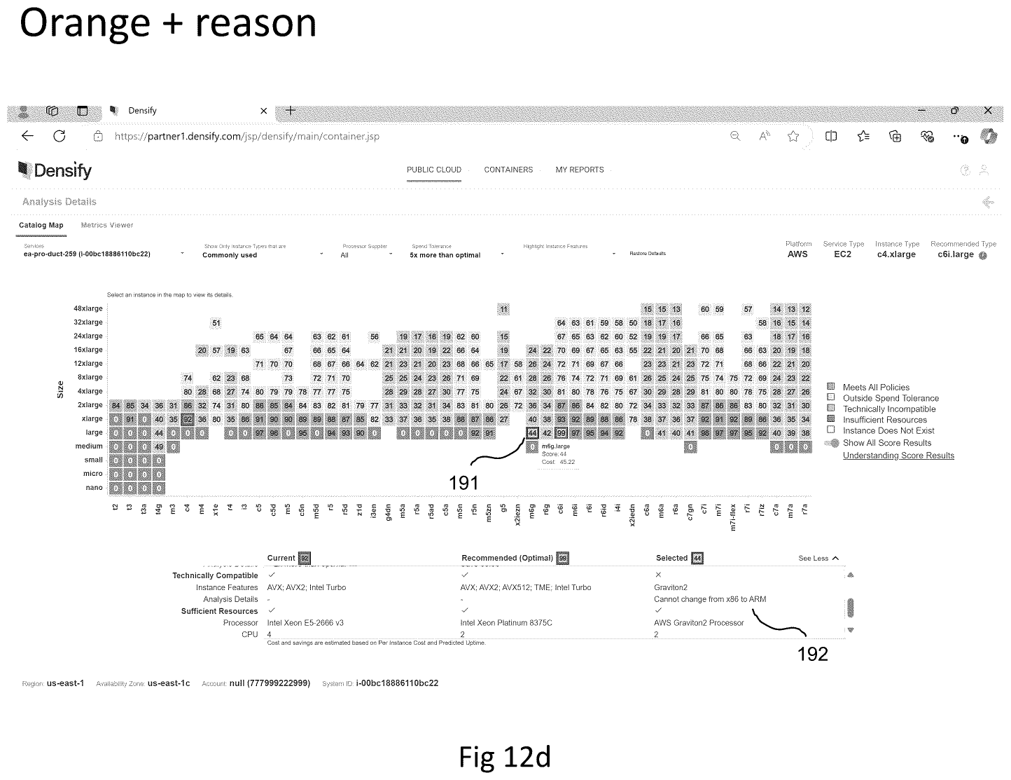

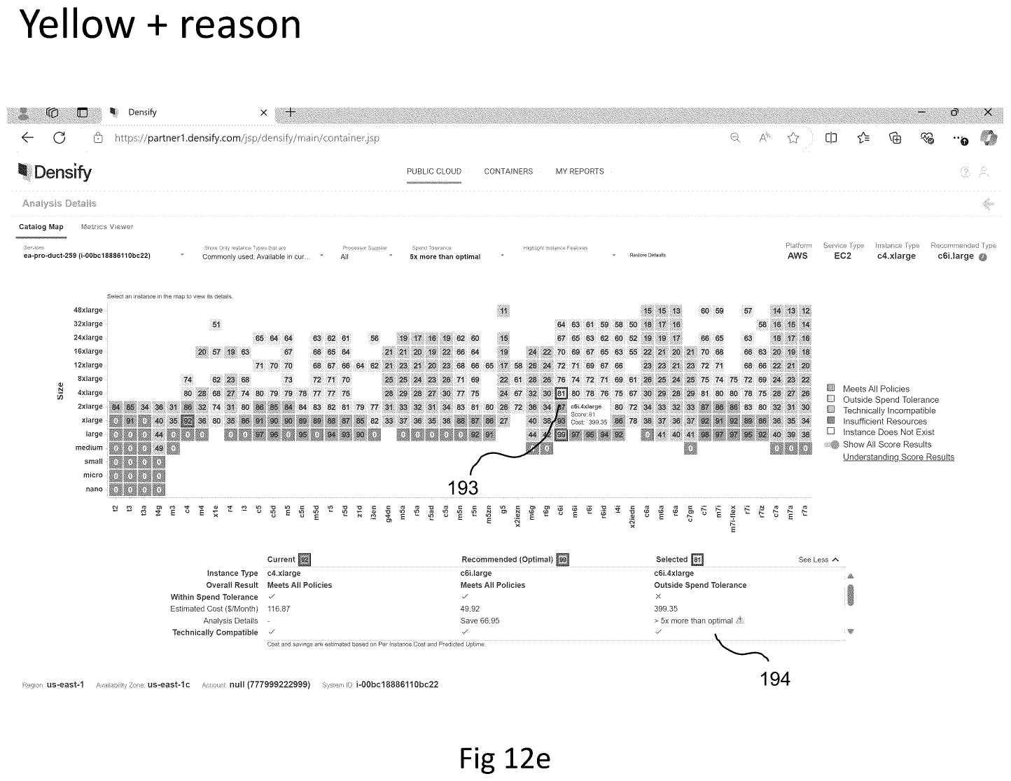

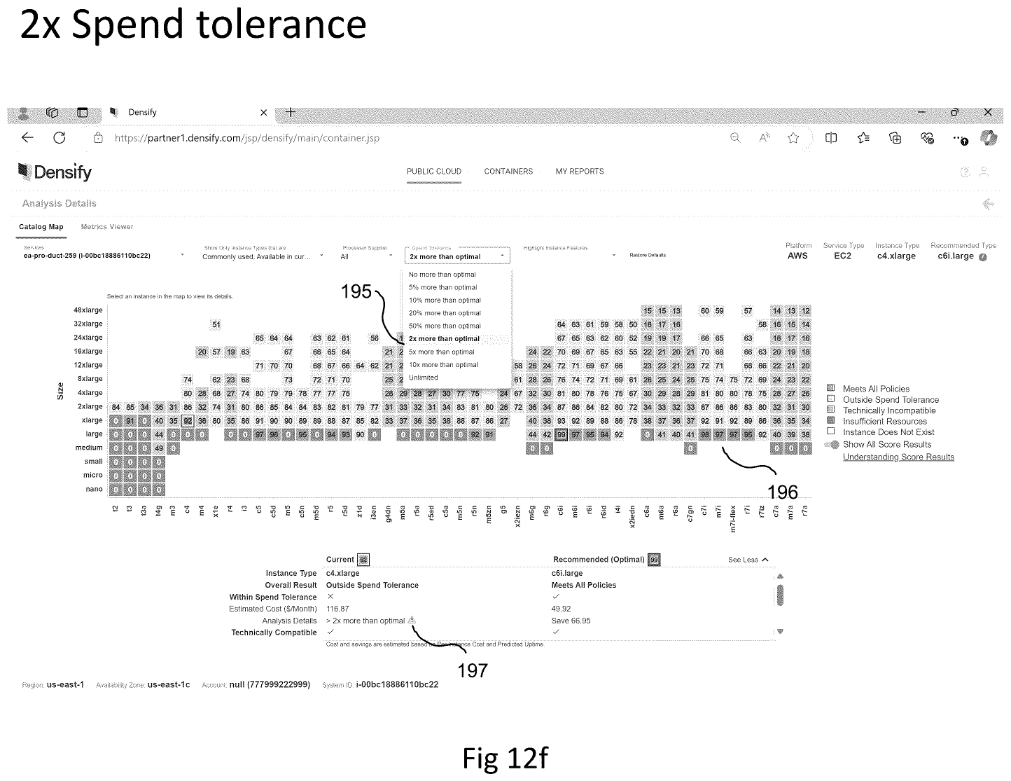

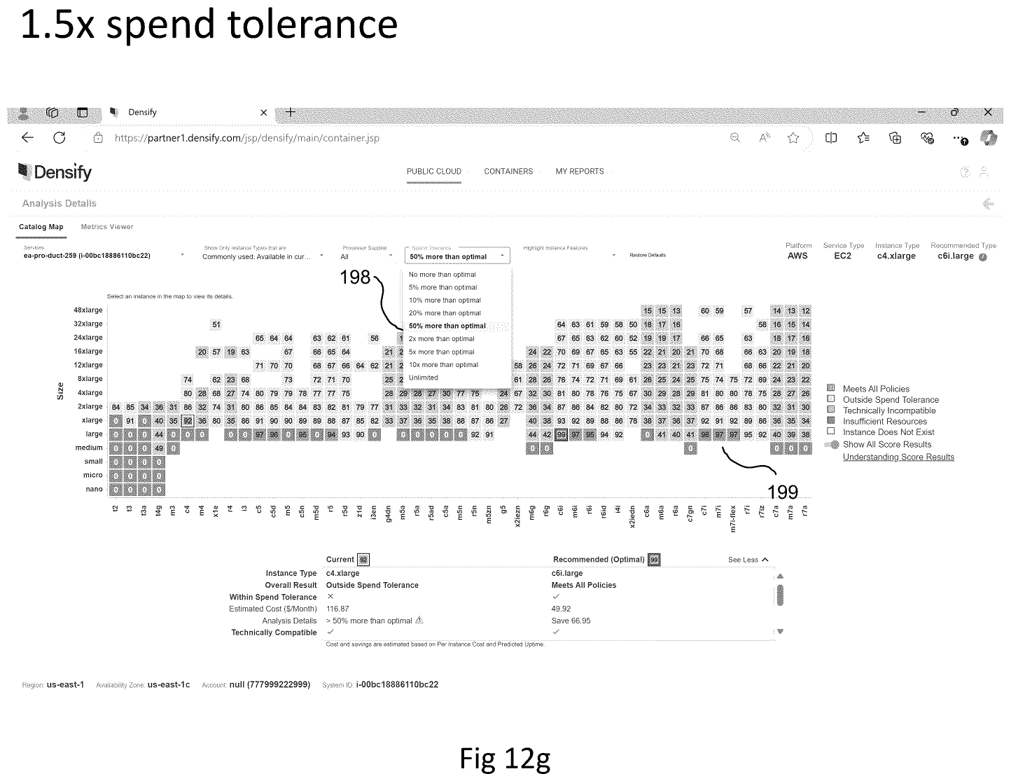

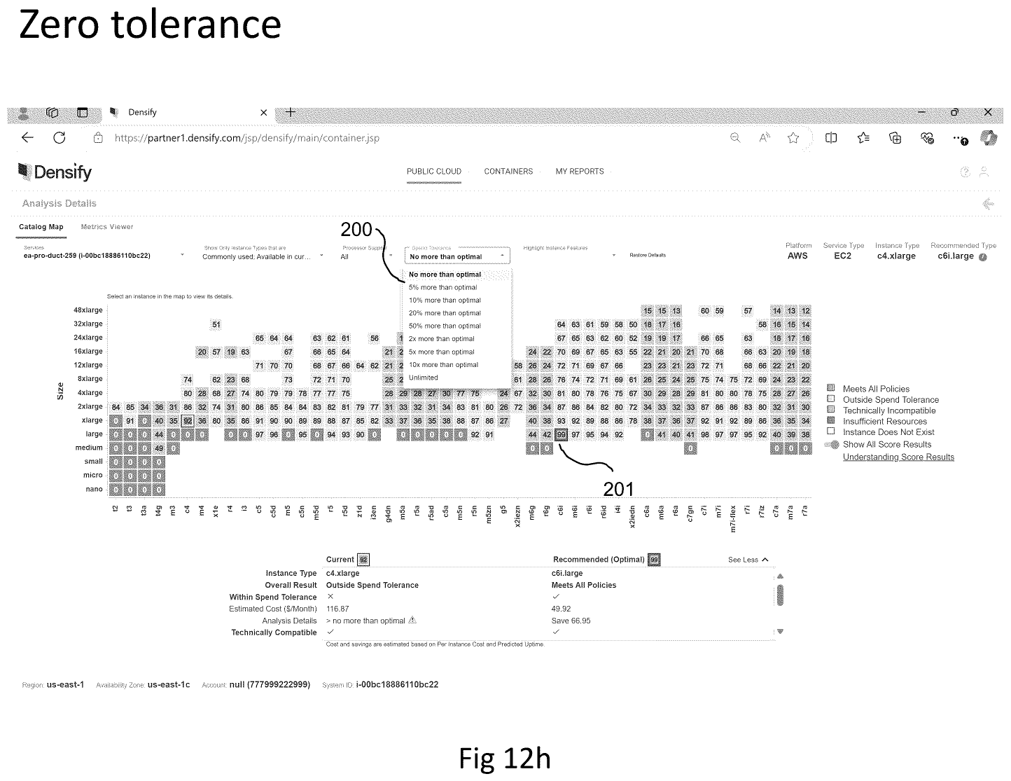

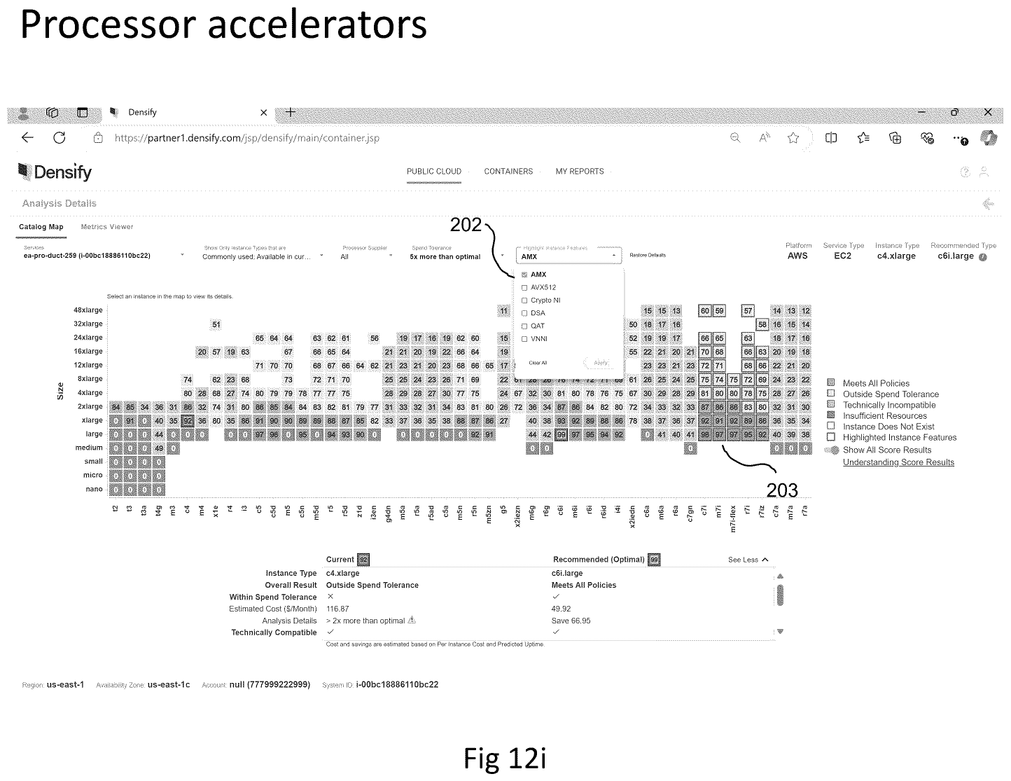

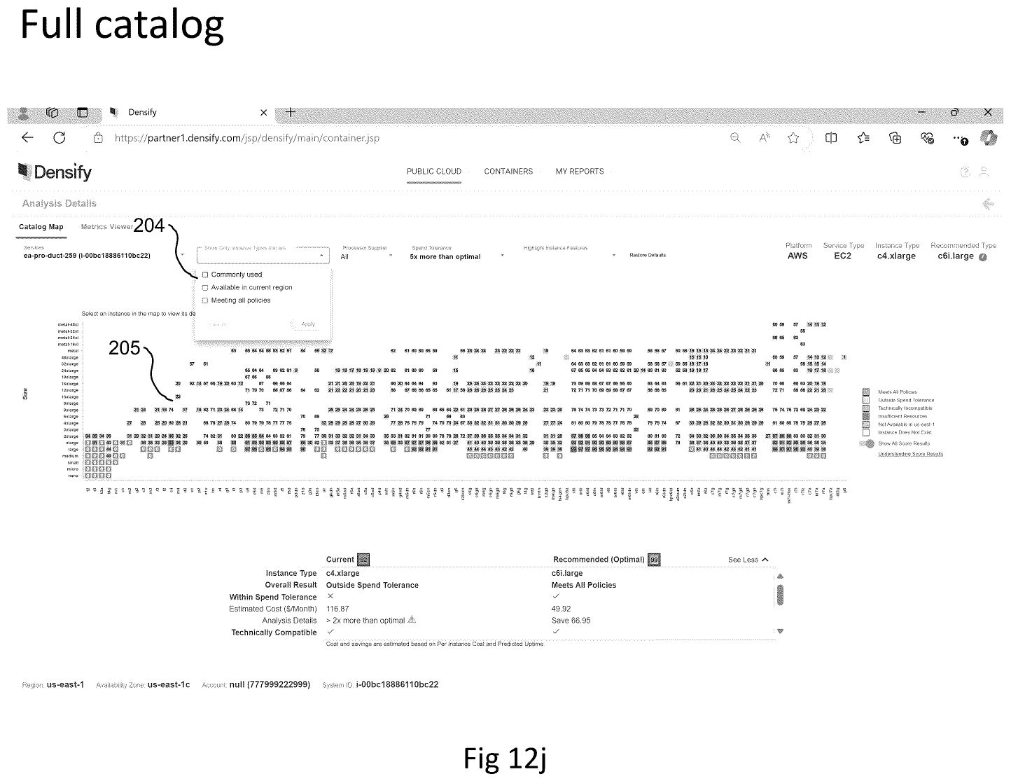

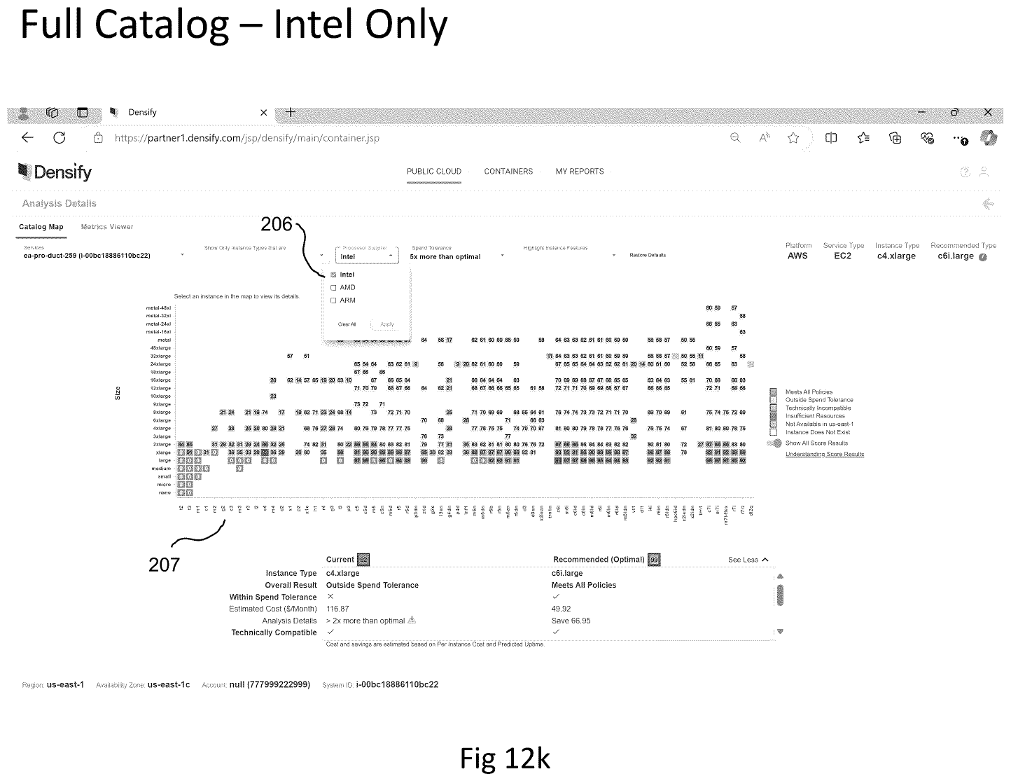

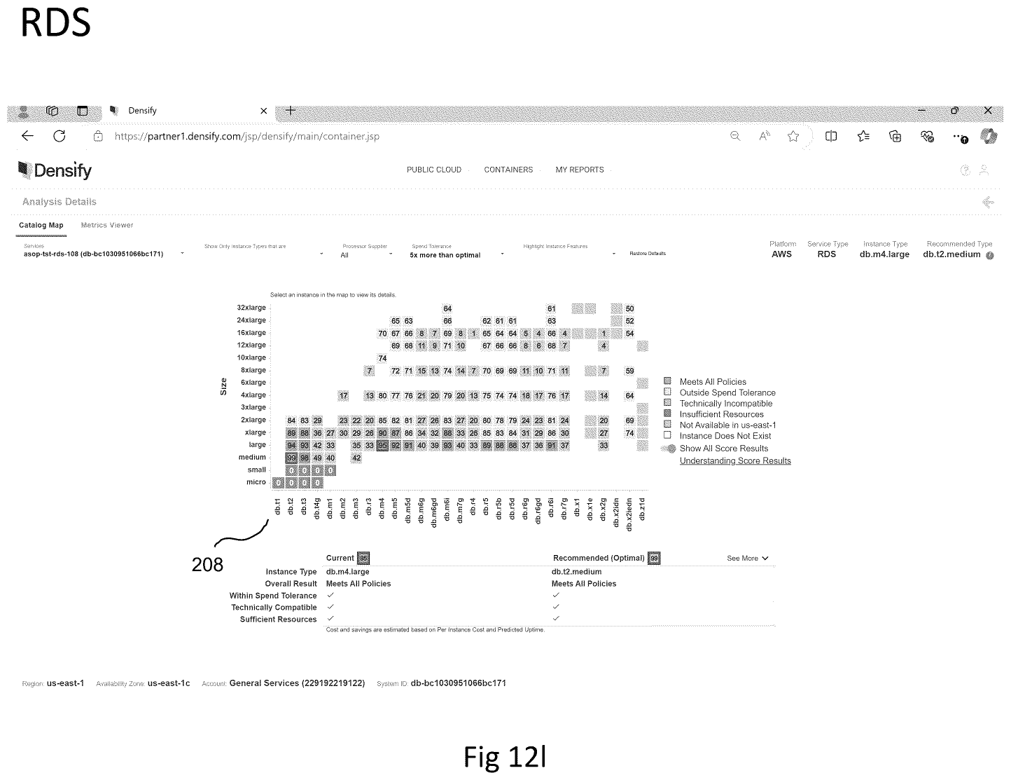

FIG. 12a shows an analysis user interface where a specific Amazon Web Services (AWS) Elastic Compute Cloud (EC2) cloud instance 171 is selected and information about that instance's utilization patterns and recommendations is displayed. This interface includes a hyperlink 172 that provides access to the catalog map for that instance.

FIG. 12b shows an actual catalog map, which is the combination of the concepts of the abstract model from FIG. 9 and the actual catalog structures described in FIGS. 10a, 10b and 11. This is the result of analyzing a specific cloud workload against the commonly used AWS EC2 instance types, and the overall shape represents the instance types that are available in the specific AWS region where this workload is running, similar to FIG. 10b.

In this catalog map, the horizontal axis 181 represented the sizes of the instances available in the cloud provider, in this case Amazon Web Services. The horizontal axis 182 represents the available instance families, with more basic instance types on the left and more advanced and/or newer instance families on the right. The instance selected is currently running on an c4.xlarge instance 183, and the recommended instance type is a c6i.large 184. It can be appreciated that the horizontal axis can be sorted using different criteria, including age, cost, capability or other criteria, including user-defined sort orders.

The red zone 185 represents the set of instance types that have insufficient resources to host the workload based on its usage of CPU, memory or other resources. The orange zone 186 represents the set of instance types that are incompatible with the workload, based on its configuration and technical requirements. And the yellow zone 187 represents the set of instances that are technically compatible and large enough to host the workload, but that are too expensive based on the selected spend tolerance. This tolerance is applied to the ratio of the cost of the instance type in a particular cell to the cost of the optimal instance 184.

The green zone 188 represents the set of instance types that are suitable to host the workload based on the selected spend tolerance. These are the set that have sufficient resources, are technically compatible, and are not outside the spend tolerance. The recommended instance type 184 is by definition included in the set of suitable instances 188.

FIG. 12c shows a case where a red cell 189 is selected, and the details section below the map shows the reason 190 why the instance type represented by that map cell, an m5.large, has insufficient resources. In this case there is not enough CPU capacity to properly host the workload.

FIG. 12d shows a case where an orange cell 191 is selected, and the details section below the map shows the reason 192 why the instance type represented by that map cell, an m6g.large, is technically incompatible with the workload. In this case the instance uses an ARM-based CPU architecture, and the workload is currently running on an x86-based architecture, which creates a binary compatibility issue that can cause the application to not work.

FIG. 12e shows a case where a yellow cell 193 is selected, and the details section below the map shows the reason 194 why the instance type represented by that map cell, a c6i.4xlarge, is outside the spend tolerance. In this case the selected instance is $399.95 per month, which is more that 5 times greater than the recommended instance type, which is $42.92 per month.

FIG. 12f shows an example where the spend tolerance 195 was reduced to 2×, meaning any instances that are more than double the cost of the recommended instance type will be flagged as outside spend tolerance. This causes the yellow area to grow and the green area 196 to shrink, as fewer instance types are within spend tolerance. In this example, the current instance also becomes outside spend tolerance 197, as it is $116.87 per month, which is more than twice as much as the recommended instance cost of $42.92 per month.

FIG. 12g shows an example where the spend tolerance 198 is further reduced to 1.5× (50% more than optimal), further reducing the set of suitable instance types and causing the green area 199 to further shrink.

FIG. 12h shows the extreme case where no overspend is tolerated 200, reducing the set of suitable instance types to a single option 201, which is the recommended instance type.

FIG. 12i shows a case where a specific processor accelerator 202 is selected, and purple highlights 203 appear to indicate which instance types contain CPUs with that accelerator. This ability to model the processor accelerators and other instance features is key to enabling the rules shown in FIGS. 7a and 7b, where the detection of software within instances enables rules to match those instances with accelerators or features that benefit that software.

FIG. 12j shows a full catalog map, where the commonly used criteria 204 is turned off, revealing a larger set of instance types. The previous figures only included instance types are commonly used within cloud customers, and by disabling this setting, more exotic and unusual instance families and sizes are visible. Because some of these are only available in certain sizes, and even in unusual sizes such as the m4.10xlarge 205, the map becomes more sparse.

FIG. 12k shows a full catalog map but with only Intel-based instance types 206 selected. The resulting map only includes instance families 207 that are based on Intel processors.

FIG. 12l shows the map a relational database service (RDS) instance running in Amazon Web Services. It is a different shape than an EC2 instance map because the available instance types 208 are distinct to that service.

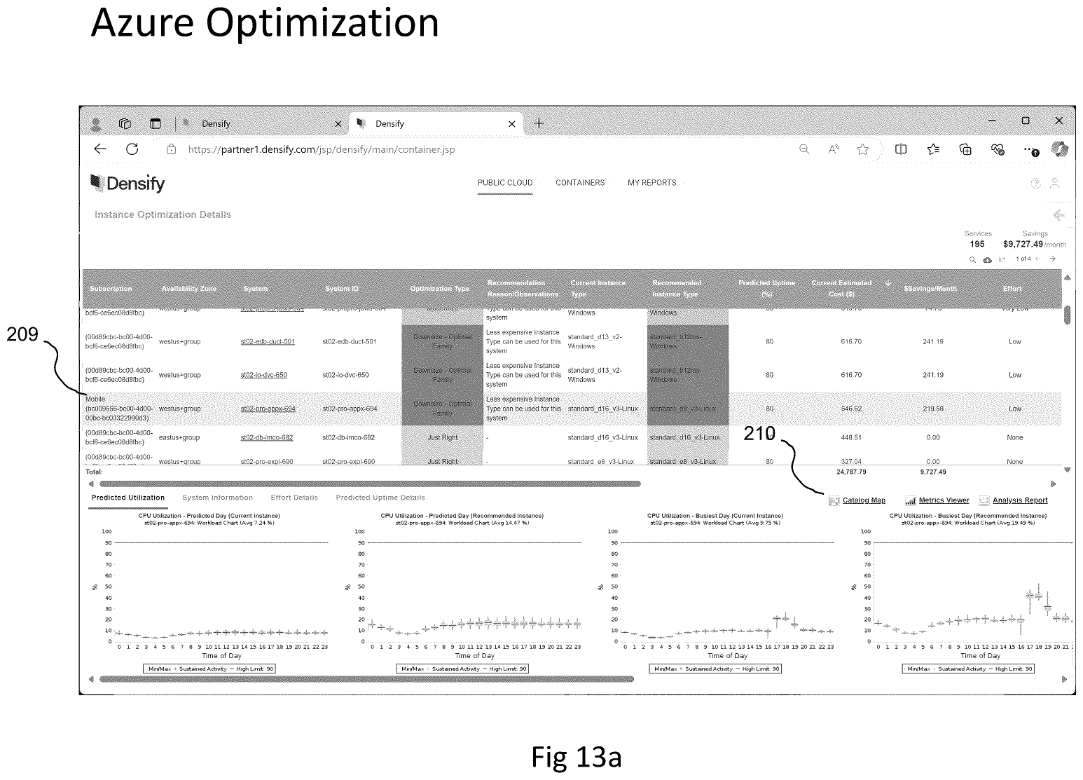

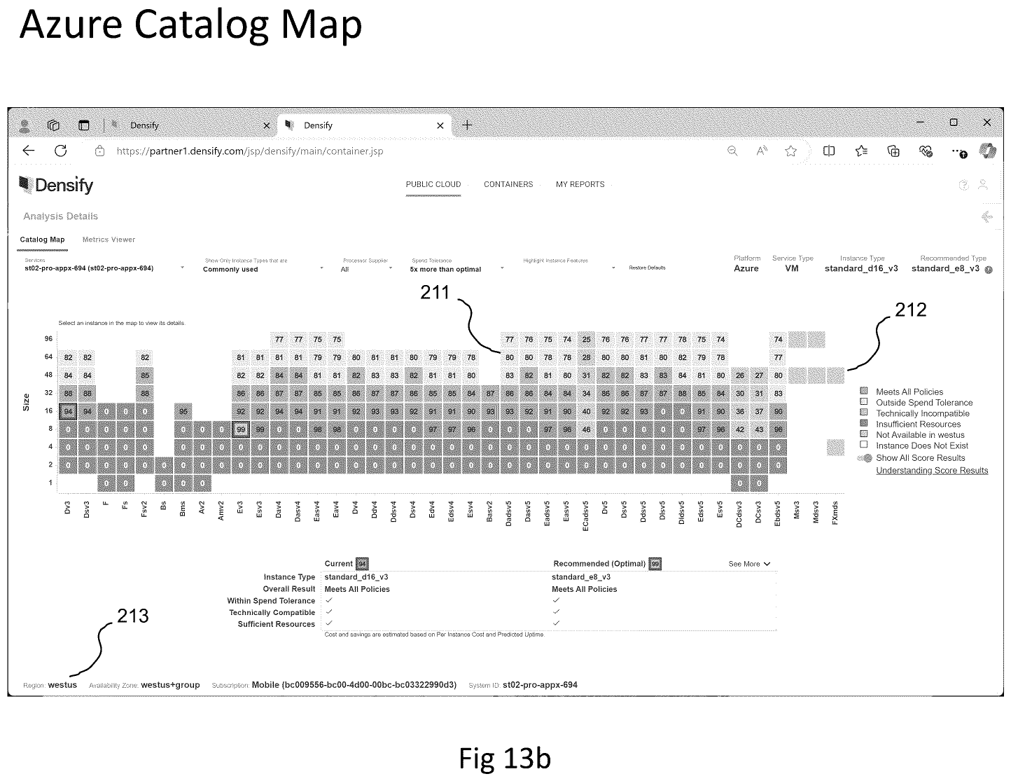

FIG. 13a shows an analysis user interface where a specific Microsoft Azure cloud instance 209 is selected and information about that instance's utilization patterns and recommendations is displayed. This interface includes a hyperlink 210 that provides access to the catalog map for that instance.

FIG. 13b shows a catalog map 211 for the selected instance, displaying the commonly used instances in Azure. Also visible in this map are the gray map cells 212 that indicate instance types that are not available in the specific region the instance is running in, in this case westus 213.

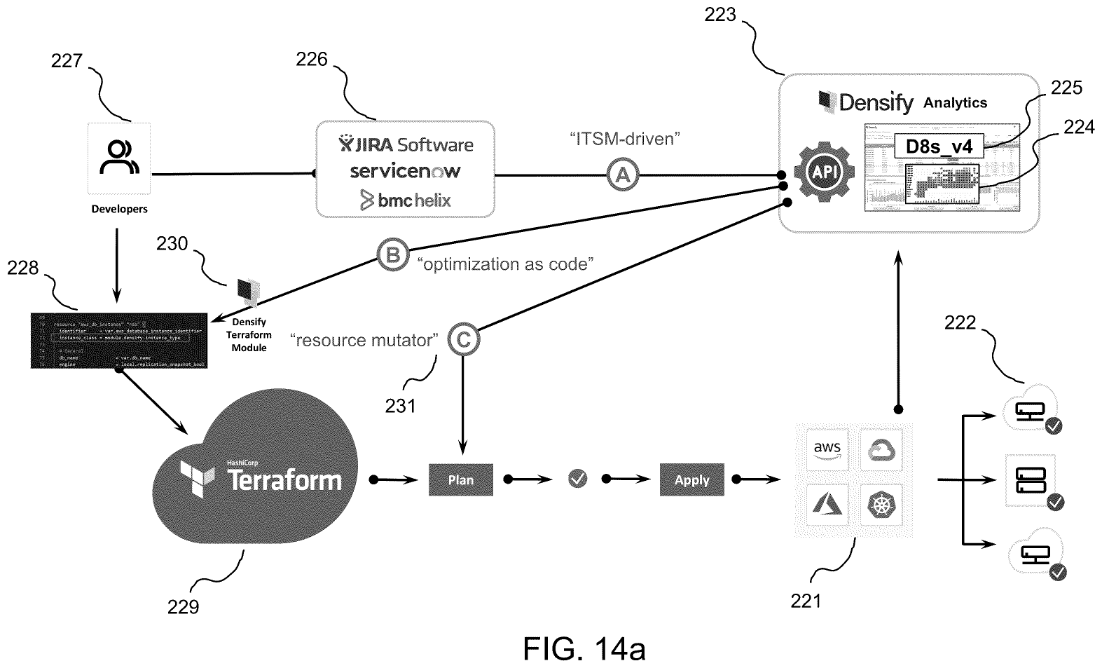

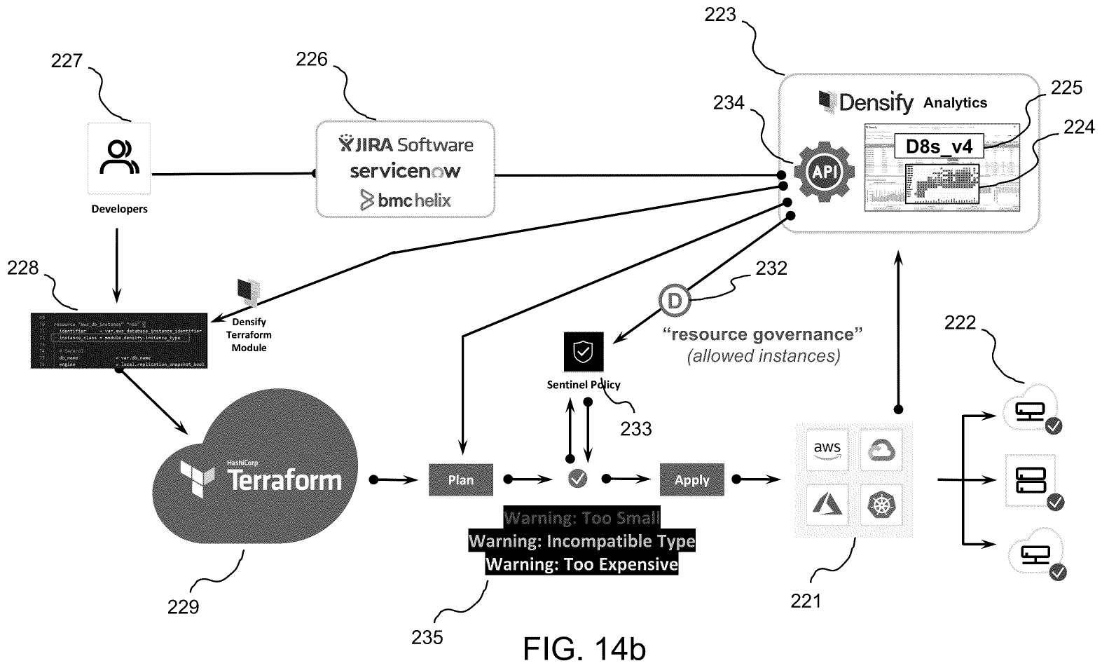

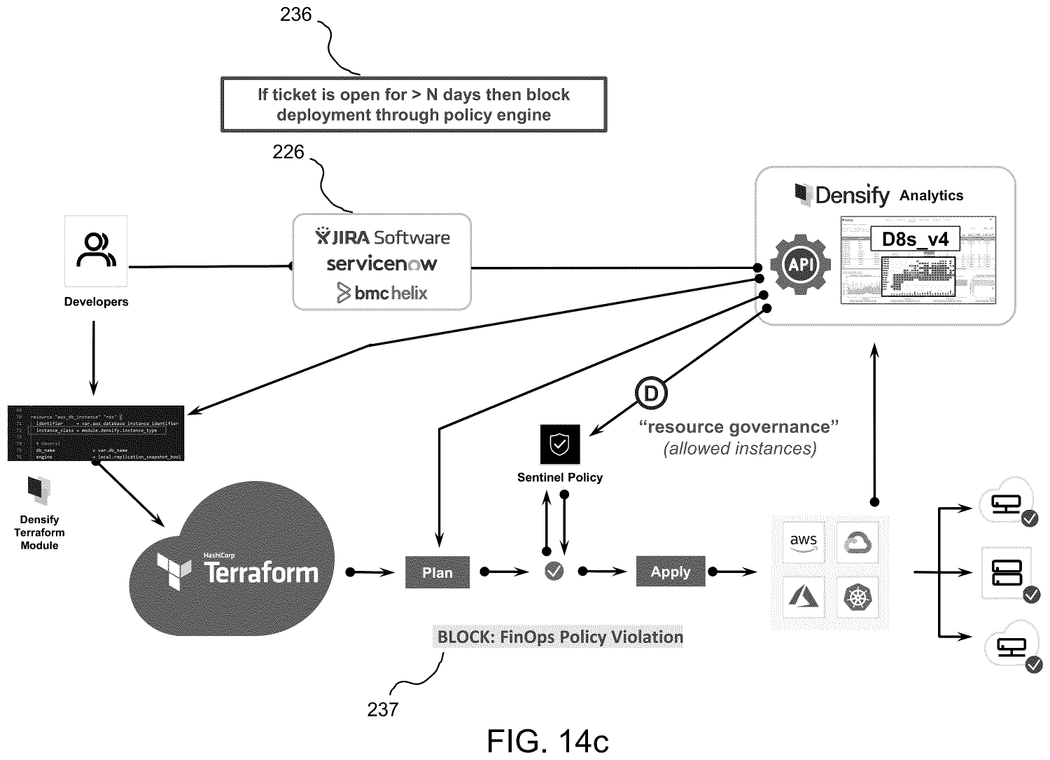

FIG. 14b is a process diagram showing the use of the catalog map to drive automation in a cloud deployment stack. A cloud service provider 221 has running cloud instances 222 that are hosting application and business service workloads. Configuration and utilization data is collected from the cloud environment by the analysis system 223, which then analyzes each workload against the catalog of instance types available from that provider. For each targeted workload this produces a catalog map 224 that includes the set of viable/suitable/acceptable instances (green), as well as the set that is not viable (yellow, orange and red). This map also includes the optimal instance recommendation 225.

The figure depicts several workflows that are made possible by this analysis output. For organizations wishing to implement the optimal instance recommendation, one option is to pass these recommendations through IT Service Management (ITSM) systems 226, which help coordinate changes to the cloud environment through a process called Change Management. The details of the recommendation are passed via API to these systems, and they open a “ticket” that is communicated to the application team 227 responsible for that specific workload. If the application team approves the change then they can implement it by modifying the launch configuration 228 of the cloud instance in order to update the instance type for that workload. This update is then processed by the deployment pipeline in use 229, in this case Terraform, in order to propagate the update to the cloud provider 221 and update the instance type to match the recommendation.

A variant of this flow is to use automation components 220 to update the launch configuration 228 automatically. In this example, an Terraform Module is used to automatically insert the recommendation into the terraform file. By adding lines of code to the launch configuration that dynamically reference the APIs to get the optimal instance type, this enables closed-loop automation without human intervention.

A third variant of this flow is to create a resource mutator 231 that can override the settings in the launch configuration 228 as the provisioning occurs. This has the advantage of enabling automation without having to change the launch configurations to include the requisite lines of code. But it has the disadvantage of creating a mismatch between the launch configuration and the running instance type in the cloud provider.

All three of these variants reference the optimal instance recommendation, and not the full catalog map. And all have the disadvantage that the application teams only get one option to implement, and if they disagree with that recommendation, then there is no alternative. They cannot exercise discretion and make alternative choices with the information they are given.

FIG. 14b depicts a unique method for driving optimization, where instead of implementing the optimal instance recommendation, policy engines are used to create “guardrails” that prevent instances from being deployed that do not meet policy. This new governance-oriented process 232 leverages policy engines 233 that are typically incorporated into the deployment pipeline to ensure that the instance type being deployed for a given workload meets all analysis policies, as represented by the green area in the catalog map.

When a user 227 specifies an instance type in a launch configuration 228, and this is deployed by the pipeline 229, the policy engine 233 will automatically intercept this and scrutinize the instance being deployed. By configuring the policy engine to call the analysis API 234 to access the catalog map for that workload, the instance type being deployed can be automatically checked against the catalog map 224 to determine if that instance type is suitable to host that workload (the green region in the catalog map). If it is then the deployment continues and the update is passed on to the cloud provider 221. If the instance type being deployed is not suitable (not green in the catalog map) then a warning can be given, with the corresponding reason 235. This effectively forms guardrails in the deployment pipeline, where any deployments that include sub-optimal instance types are caught, and warnings given.

FIG. 14c is a variant of this flow where warnings generated from the rule engine can also be used to open tickets in the ITSM System 226. If sufficient time passes 236 and the deployed instance is not corrected to be one of the suitable instances in the catalog map then the warning can be escalated. In this case, the policy engine is configured to block the deployments 237, and not just generate a warning. This enables organizations to give application teams time to respond before adopting a more strict enforcement policy.

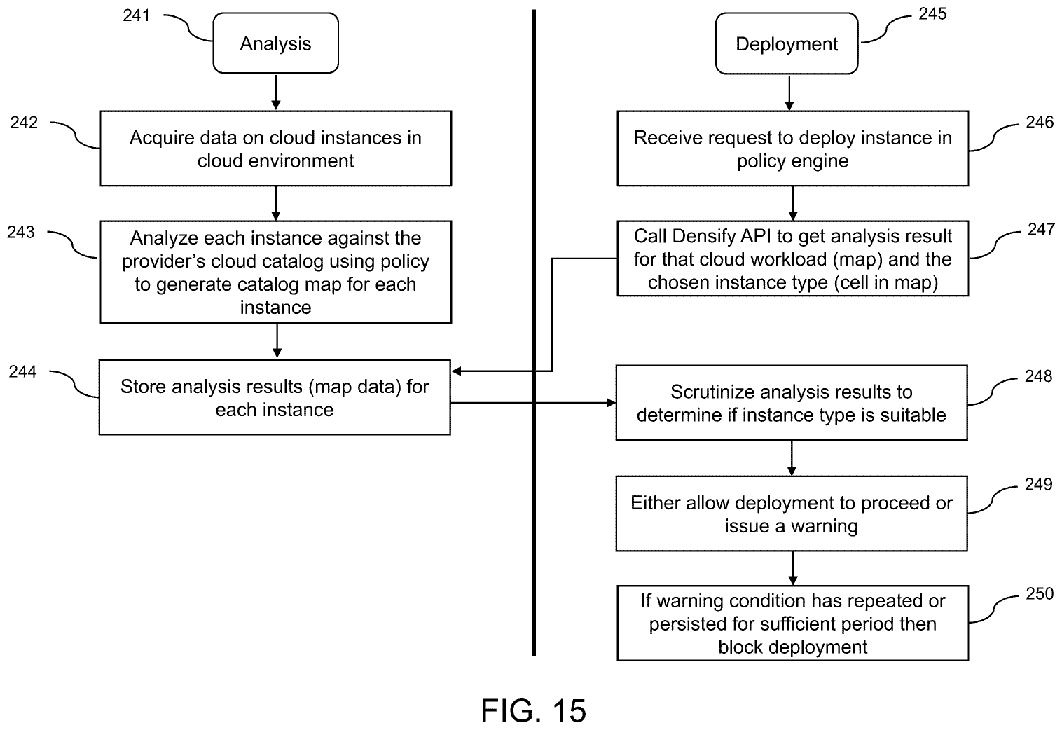

FIG. 15 is a flowchart showing this guardrail-based workflow, and there are two parts to this flow. Firstly, the analysis process 241 acquires data from the cloud provider pertaining to the cloud instances in use 242. It then analyzes each instance's data against that cloud provider's catalog using policy in order to construct a catalog map for each instance 243. Finally, it persists these analysis results for future reference 244.

The next time a cloud instance deployment occurs 245, the policy engine receives the details of the deployment 246, and calls the densify API to acquire the analysis results for that specific instance and the instance type being requested 247. This request corresponds to a specific cell in a specific map, and based on the details of that cell it can be determined if that instance type is suitable for use in that instance 248. Based on this, the deployment will either be allowed to proceed, or a warning will be issued 249. Optionally, a method can be used to track whether the warning is persistent or repeating, meaning it is being ignored by the application team, and the warning escalated to actually block the deployment 250.

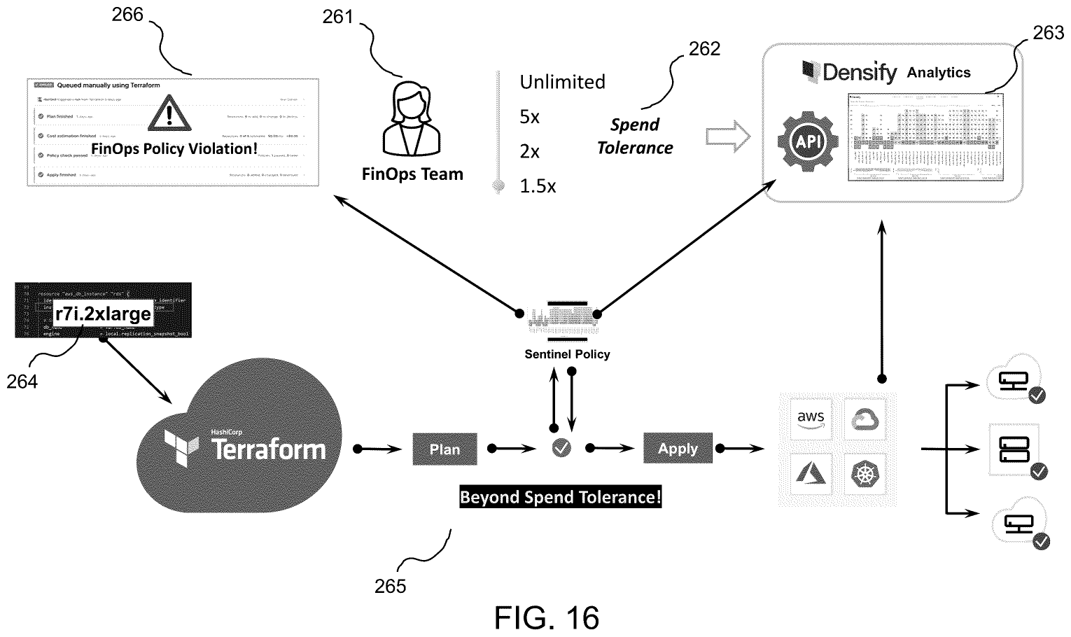

FIG. 16 shows a flow where a member of a Financial Operations team, or FinOps team 261 adjusts the send tolerance policy 262, causing the analysis map 263 to reflect a new set of suitable instance types for a specific workload. If the instance type 264 used for that workload is no longer suitable from a cost perspective, this will generate a spend tolerance warning 265. This flow mirrors the spend tolerance adjustments depicted in FIGS. 12f, 12g and 12h, and is integrated into the deployment pipeline in order to automate the enforcement of the spend tolerance policy. This effectively creates guardrails to control the instance types used by application teams.

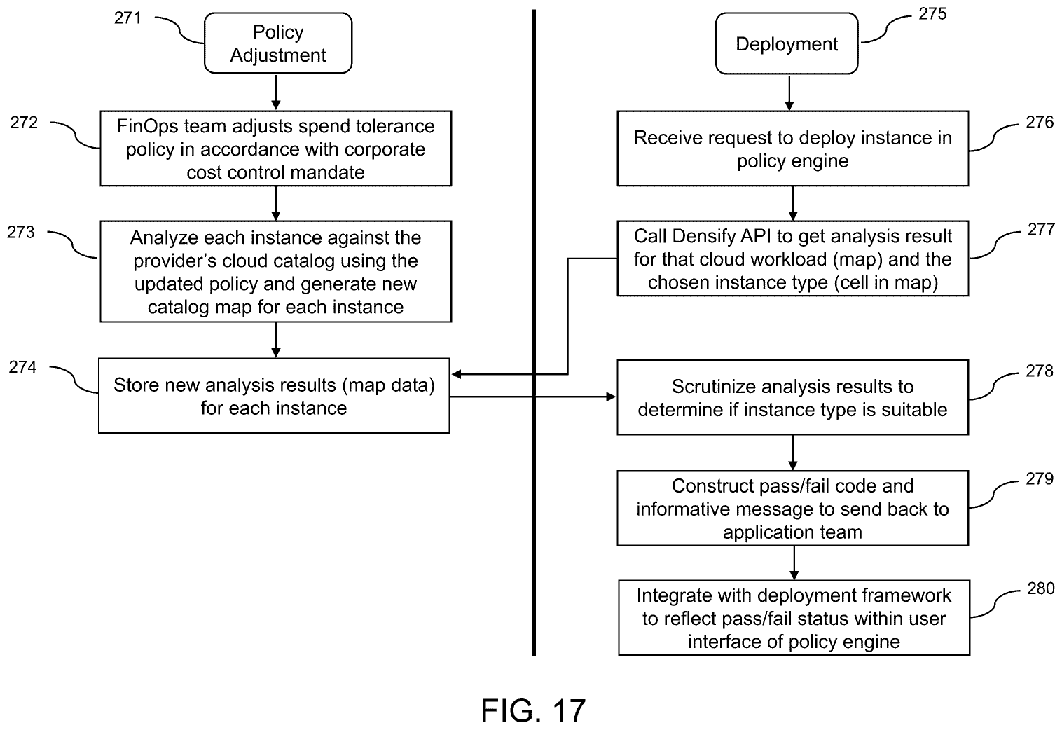

FIG. 17 is a flowchart depicting the flow from FIG. 16 reflecting a policy adjustment 271. The FinOps team updates the spend tolerance policy 272 either to increase cost efficiency (lower tolerance for wasting money) or to give application teams more freedom (higher tolerance for wasting money). Based on this, the instances are re-analyzed using the new policy and a new set of maps is generated 273. These new analysis results are then stored 274.

As with FIG. 15, when a deployment is initiated 275 the policy engine receives the details of the deployment 276, and calls the densify API to acquire the analysis results for that specific instance and the instance type being requested 277. From this it can be determined if that instance type is suitable for use in that instance 278, and a pass/fail code plus an informative message can be constructed 279. This is then integrated into the deployment framework in order to provide pass/fail and warning messages directly to the application teams. Note that this mechanism is not different that the flows described in FIGS. 14b, 14c and 15, but FIGS. 16 and 17 just provide more detail on where the warnings actually go.

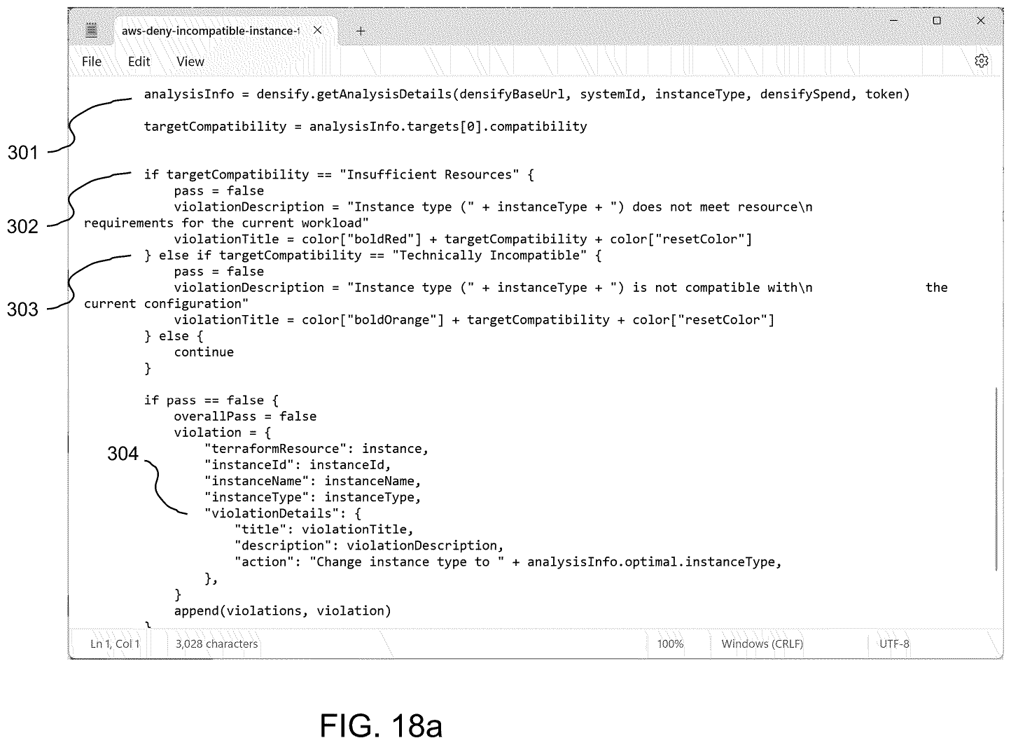

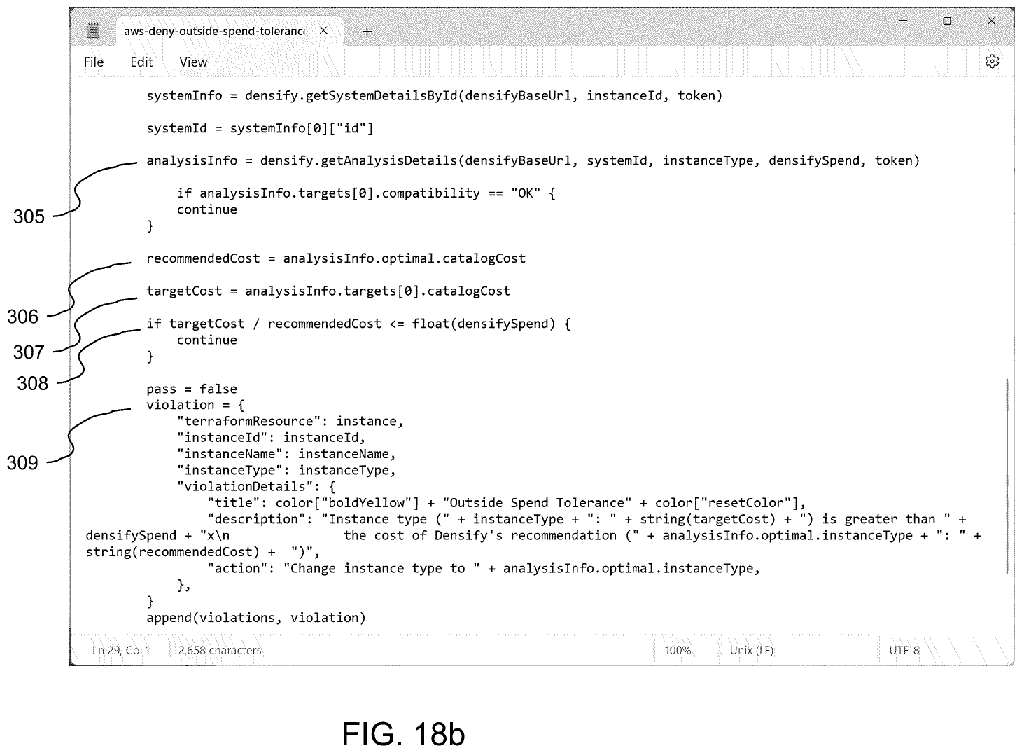

FIG. 18a is a source code snippet from a policy called aws-deny-incompatible-instance-type, which is used by the policy engine (in this case Hashicorp Sentinel) to enforce technical and resource guardrails on the instances being deployed based on the catalog map. The function will retrieve the analysis details 301 from the analysis server using an API, and then check whether the instance being deployed has insufficient resources 302. If so then the check is deemed to have failed, and a warning message is constructed for display to the application developers. If there are sufficient resources then a second check 303 is performed to determine if the instance type being deployed is technically incompatible. If so then the check is deemed to have failed, and a warning message constructed for display to the application developers. If either of these checks fails then additional information 304 is appended to the message to provide details on how to remediate the issue.

FIG. 18b is a source code snippet from a policy called aws-deny-outside-spend-tolerance, which is used by the same policy engine to enforce financial guardrails on the instances being deployed based on the catalog map. This function retrieves the analysis details 305 from the analysis server using an API, and determines both the cost of the recommended instance type 306 as well as the cost of the instance type being deployed 307. A check is then done 308 to determine if the ratio of the two is within the spend tolerance, and if so then the deployment is allowed. If not then the check is deemed to have failed, and a warning message is constructed 309.

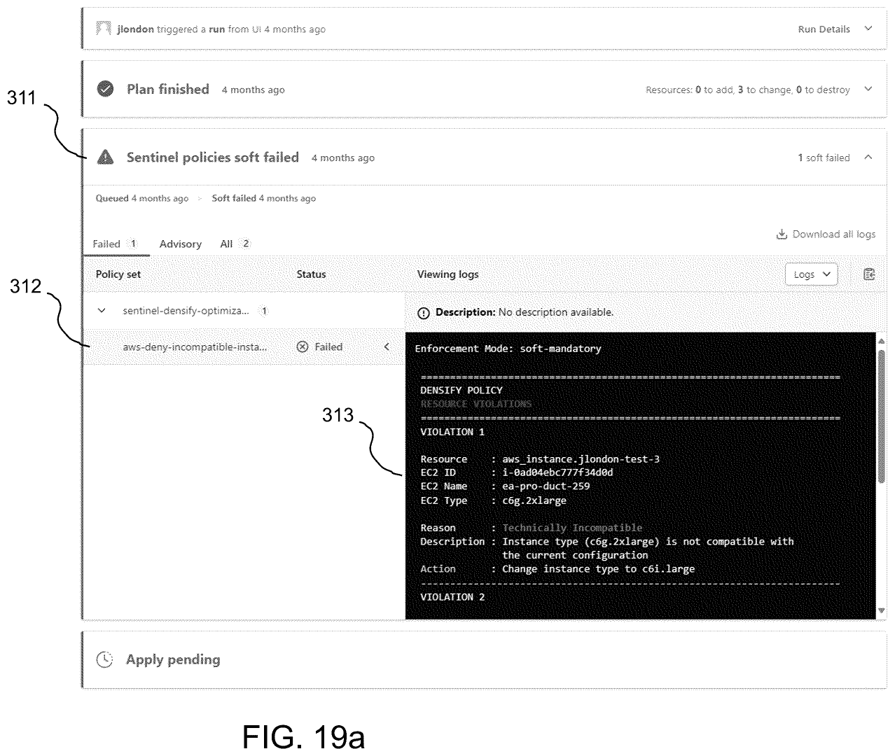

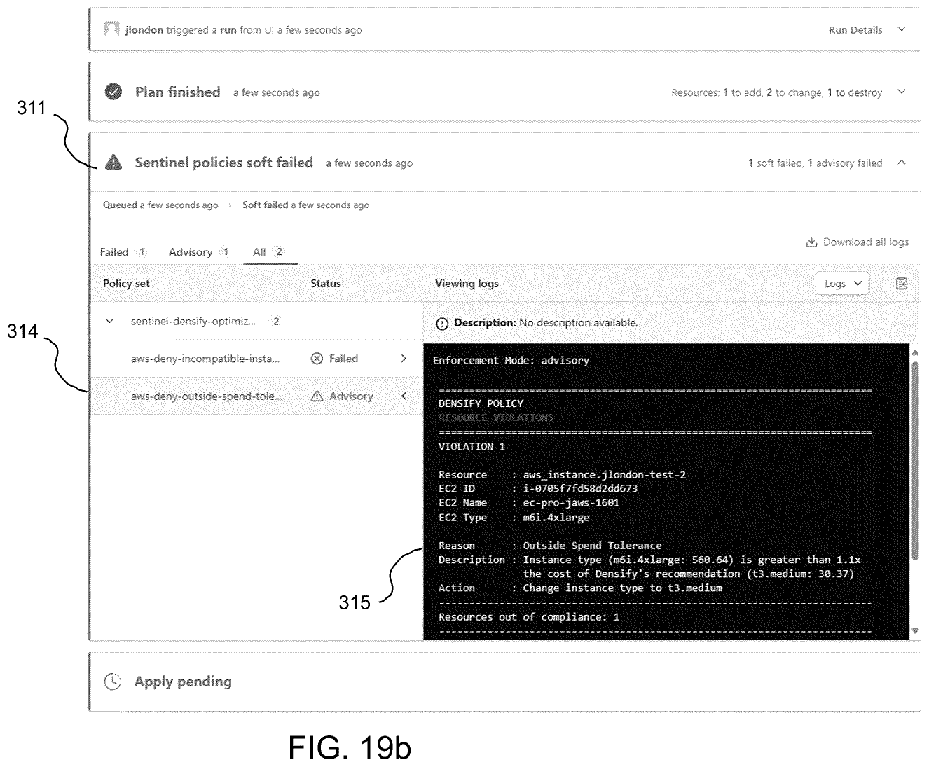

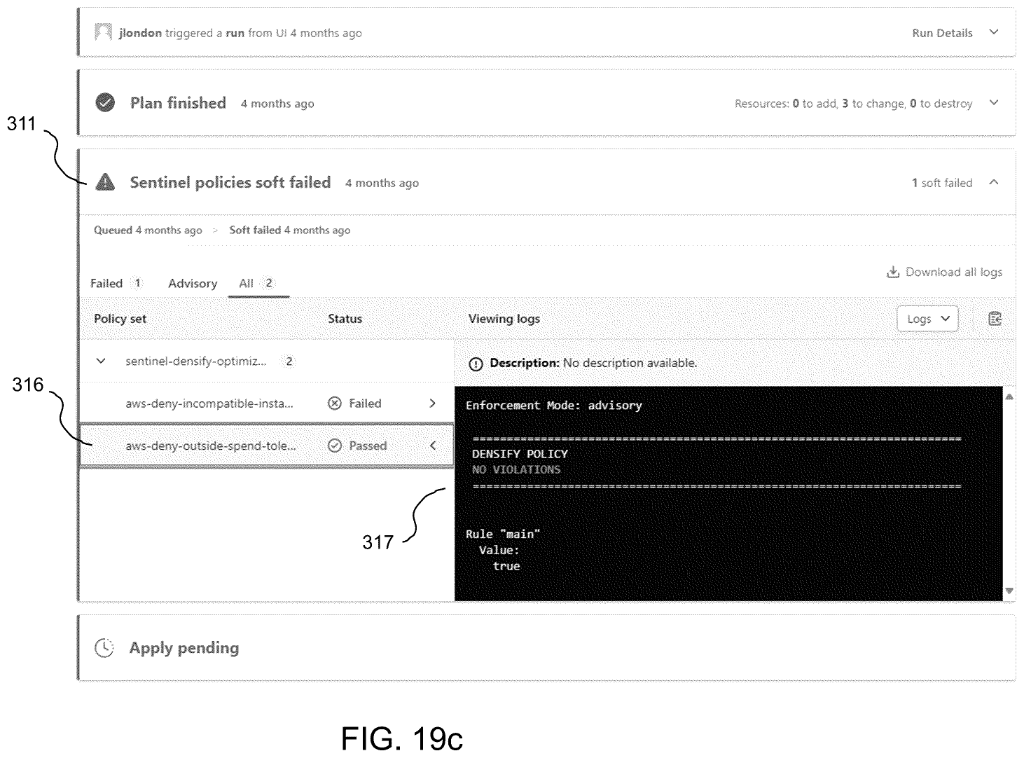

FIG. 19a is a cloud deployment console, in this case Hashicorp Terraform, showing the deployment of a cloud instance. In this case the policy engine, Sentinel, is reporting failed policies 311 during the deployment. The policy failing is the aws-deny-incompatible-instance-type 312 described in FIG. 18a, and the detailed message 313 is a technical incompatibility warning as described in FIG. 18a. Because this console is used by developers, engineers and app teams to deploy applications, this warning goes directly to the user that is responsible for the instance being deployed, providing a guardrail to prevent the deployment of incompatible instance types.

FIG. 19b shows an additional failed policy 314, in this case the aws-deny-outside-spend-tolerance policy described in FIG. 18b. The detailed message 315 is as shown in FIG. 18b, and provides a financial guardrail to prevent the deployment of unnecessarily expensive instance types.

FIG. 19c shows a case where the aws-deny-outside-spend-tolerance policy 316 is determining that the instance type being deployed is within the spend tolerance, and therefore no policy violations are being reported.

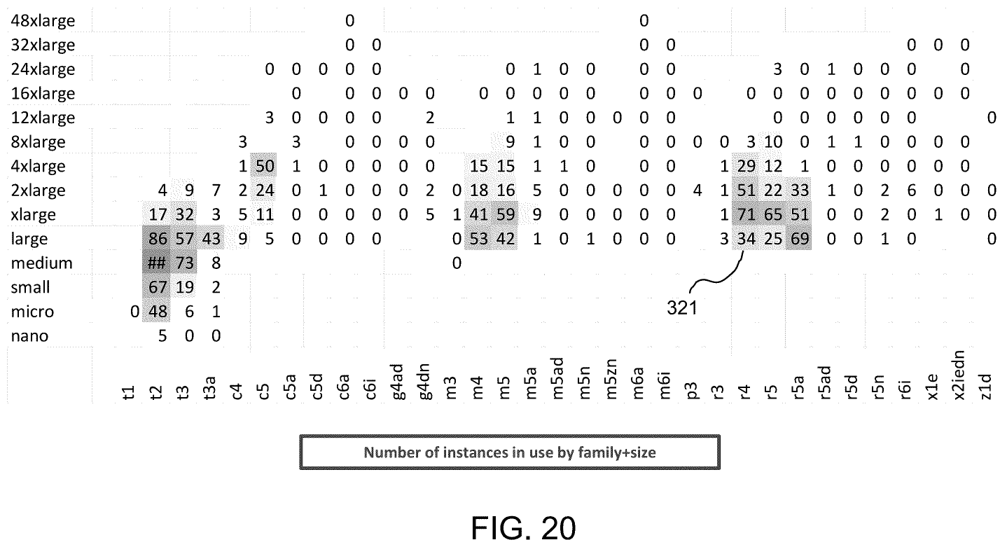

FIG. 20 shows an alternate use of the catalog map structure, where instead of scoring a specific workload against the cells of the map, the cells are used to indicate the number of instances 321 of that family and size in use in an environment (or across multiple environments). The resulting heat map shows the frequency of use of the various instance types, providing a concise summary of the instance type landscape for a line of business, cloud account, entire company, or any logical group of systems.

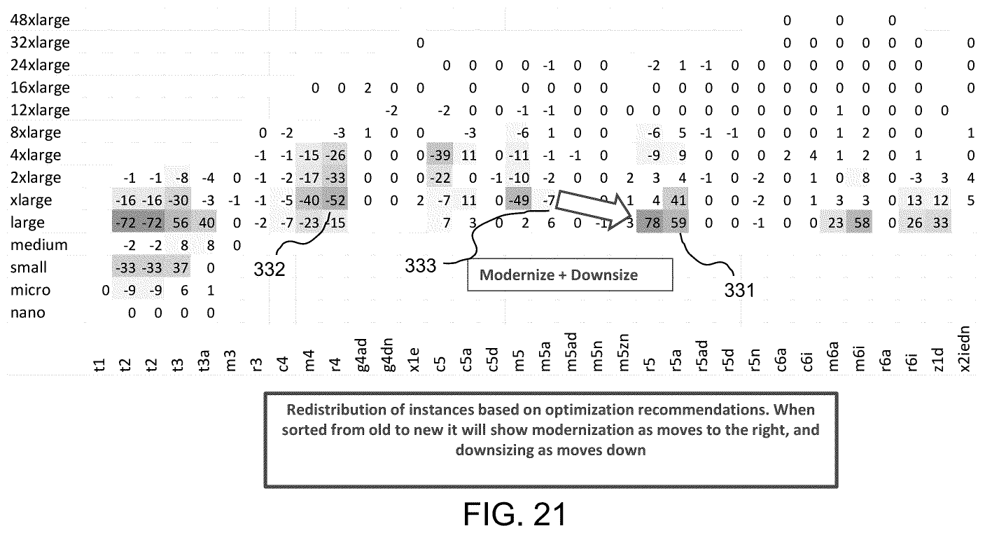

FIG. 21 shows a differential view in the catalog map, where the cell values indicate the net change in the number of instances of that type in use. In this example, the positive numbers 331 represent instance types that increase in use as a result of optimization, and the negative numbers 332 represent instance types that decrease in use. This provides a predictive view of what the distribution of instance types will be if all of the recommendations are implemented. Because many cloud environments contain instances that are oversized and/or old, the trend shown in this example is that the instances “move” downward and to the right 333. This means the resulting state of the environment will generally be modernized and downsized (newer and smaller).

Note that this representation can also be used to show the delta between two points in time.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment shown in the above-described figures, any component of or related thereto, such as a computing device 30, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A method for analyzing an application workload running in a cloud instance against a cloud provider's catalog and identifying at least one of:
a) the instance types and sizes that are unable to host the workload because they have insufficient CPU, memory or other resources to properly service the workload;
b) the instance types and sizes that are unable to host the workload because their technical characteristics and configurations are not suitable for the workload, wherein this can include local disk availability, disk and network configurations, hypervisor compatibility, and other considerations;
c) the instance types and sizes that are not suitable to host the workload because their cost is outside the acceptable range for that workload; or
d) the instance types that are not ruled out by any of these assessments, and hence are suitable for hosting the workload.

2. The method of claim 1 where the acceptable range for the cost of an instance is calculate relative to the optimal instance type for that workload, where the optimal instance type is determined using an optimization function that factors in utilization, technical compatibility and cost.

3. The method of claim 2 where the acceptable range for the cost relative to the optimal instance is defined by a spend tolerance policy, which expresses the maximum acceptable cost as a multiple of the cost of the optimal instance.

4. The method of claim 1 where the technical criteria include whether a given catalog instance has hardware accelerators or other features that will cause it to have a performance, security or cost advantage over other instance types for the specific software that is running in the workload being assessed.

5. A system visualizing the assessment of the method performed in claim 1.

6. An API to respond to queries as to whether a specific instance type is suitable for hosting a specific workload used with the method of claim 1.

7. A method for controlling the deployment of cloud instances in a cloud computing environment, the method comprising:
a) analysing an existing cloud workload's configuration and utilization data against a cloud provider's catalog of available instance types;
b) identifying the instance types in the catalog that have insufficient resources to host the workload based on the utilization characteristics of the workload and the resource capacity of the instance types;
c) identifying the instance types in the catalog that are technically incompatible with the workload based on it's technical and configuration requirements;
d) identifying the instance types in the catalog that are too expensive based on a spend tolerance policy;
identifying the instance types in the catalog that are deemed suitable to host the workload, by virtue of them not having failed the resource, compatibility and cost checks; and
either allowing a deployment to proceed, issuing a warning, or blocking the deployment of a cloud instance based on whether the instance type being deployed is suitable for that cloud workload based on this analysis.

8. The method of claim 7 where the spend tolerance policy us evaluated based on the ratio of the cost of the instance type being deployed to the optimal instance type in the entire catalog.

9. A method of visualizing a 2-dimensional catalog map for a specific cloud instance, where said map has one dimension representing the instance families present in the cloud provider and another dimension representing the instance sizes, and for each family and size combination that exists in the catalog, a colour coded cell is depicted.

10. The method of claim 9, wherein the color coded cell is based on the logic described in claim 7.
